(19) United States
(12) Patent Application Publication
(10) Pub. No.: US 2011/0016492 A1
(43) Pub. Date: Jan. 20, 2011

(54) SYSTEMS AND METHODS FOR FORWARDING MEDIA ASSET EVENTS

(75) Inventor: Yoshihiko Morita, Tokyo (JP)

Correspondence Address: ROPES & GRAY LLP, PATENT DOCKETING 39/361, 1211 AVENUE OF THE AMERICAS, NEW YORK, NY, 10036-8704, US

(73) Assignee: Gemstar Development Corporation, Santa Clara, CA (US)

(21) Appl. No.: 12/504,191

(22) Filed: Jul. 16, 2009

(51) Int. Cl. H04N 5/445

(52) U.S. Cl. 725/58

(57) ABSTRACT

Systems and methods are provided for forwarding media asset events. A media asset event may be scheduled on a first device for a particular time. At the particular time, the first device may determine whether the user is within a perceivable range of the first device and may provide access to the media asset when the user is within a perceivable range of the first device. If the user is outside a perceivable range of the first device, data associated with the media asset event may be automatically transmitted to a second device. If the user is within a perceivable range of the second device, the media asset and media asset event may be provided to the user on the second device. If the user is outside a perceivable range of the second device, the media asset may be stored to on the second device and/or forwarded to another device.

### BACKGROUND OF THE INVENTION

This application relates to interactive media guidance applications and more particularly to forwarding of media asset events (e.g., reminders for media assets) from one device to another.

Traditional systems allow reminders to be scheduled for programs of interest that are not readily available or that the user is unable to access (e.g., because of a current or future schedule conflict). Such reminders notify the user at a particular time (e.g., before the program becomes available) that the program of interest is about to begin. The user may then act on the reminder notification to either record or watch the program of interest.

The traditional systems, however, require that the user be present or within some perceivable range of the device to receive the reminder notification. For example, some systems display a prompt on the monitor (or provide an audible alert) that notifies the user that the program of interest is about to begin. Such a prompt (or audible alert) is ineffective when the user is not watching the monitor (or cannot hear the speakers of the device) at the time the prompt is provided or within some period before the program starts.

### SUMMARY OF THE INVENTION

In view of the foregoing, it would be desirable to provide systems and methods for forwarding media asset scheduled events (e.g., media asset reminders) from one device to another. In particular, it would be desirable to provide a system that, when the user is not within (or is outside) a perceivable range of a first device, (1) provides the media asset event (e.g., reminder) and/or the media asset to the user on a second device and (2) when necessary stores the media asset to a storage device of the second device. As defined herein the term “forward” or “forwarding” means the transfer of an event previously scheduled for action or execution by a first device to one or more other devices for action or execution.

A user may schedule a media asset event on a first device for a particular time. For example, a user may schedule a reminder for a program using a television equipment device. The reminder may be set up to be provided at a particular time, such as five minutes before the program beings.

At the particular time, the first device may determine whether the user is within a perceivable range of the first device. As defined herein the term “perceivable range” means a distance a user is from a device such that the user can see, hear, feel or otherwise perceive content provided by the device. For example, the first device may determine, at the particular time, whether the user is within a perceivable range of the first device by displaying a visual cue and requesting response within a particular amount of time (e.g., 30 seconds).

Monitor circuitry on the first device may implement various mechanisms by which to determine whether the user is within a perceivable range of the first device. The determination may be made before, during or after the media asset event is provided on the first device. The determination allows the first device to know whether the user can receive the media asset event and/or the media asset using the first device.

When the user is within a perceivable range of the first device, the first device may provide access to the media asset event (e.g., by displaying the scheduled reminder) and provide access to the media asset. When the user is outside a perceivable range of the first device, the first device may forward data associated with the media asset event to a second device (e.g., a mobile communications device). For example, the first device may transmit a media asset event data structure to the second device.

The second device may determine whether the user is within a perceivable range of the second device when the second device receives the data associated with the media asset event. The second device may use monitor circuitry to determine whether the user is within a perceivable range of the second device. In particular, the second device may use mechanisms similar to those used by the first device to make the determination.

When the user is within a perceivable range of the second device, the second device may provide access to the media asset event (e.g., by displaying the scheduled reminder) and provide access to the media asset associated with the event. When the user is outside a perceivable range of the second device, the second device may store the media asset associated with the media asset event to a storage device of the second device. Alternatively or in addition to storing the media asset, the second device may forward the data associated with the media asset event to a third device. The third device may function in a similar manner as the second device to provide access to the media asset, store the media asset and/or forward the media asset to another device.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with an embodiment of the invention;

FIG. 3 shows an illustrative user equipment device in accordance with another embodiment of the invention;

FIG. 4 is a diagram of an illustrative cross-platform interactive media system in accordance with another embodiment of the invention;

FIG. 5 is an illustrative display of a media asset event forwarding menu screen in accordance with another embodiment of the invention;

FIG. 6 is an illustrative display of a media asset event scheduling screen in accordance with another embodiment of the invention;

FIG. 7 is an illustrative display of a device set up screen in accordance with another embodiment of the invention;

FIG. 8 is an illustrative display of a calendar for media asset event forwarding screen in accordance with another embodiment of the invention;

FIG. 9 is an illustrative display of a scheduled media asset events screen in accordance with another embodiment of the invention;

FIG. 10 is an illustrative display of a perceivable device range configuration screen in accordance with another embodiment of the invention;

FIG. 11 shows a system for providing media asset event forwarding in accordance with another embodiment of the invention;

FIG. 12 shows an exemplary data structure for a media asset event in accordance with an embodiment of the present invention;

FIG. 13 is an illustrative display of a media asset event prompt provided on a second device in accordance with another embodiment of the invention; and

FIGS. 14 and 15 are illustrative flow diagrams for forwarding media events from one device to another in accordance with embodiments of the present invention.

### DETAILED DESCRIPTION OF EMBODIMENTS

This invention generally relates to forwarding media asset scheduled events from one device to another. Such scheduled events may include reminders, scheduled recordings, ordered programs (e.g., pay-per-view), lists of editors picks, or any other type of media asset related action triggered at a predetermined time. For illustrative purposes, this invention will be described in the realm of forwarding from one device to another scheduled media asset reminder.

The amount of media available to users in any given media delivery system can be substantial. Consequently, many users desire a form of media guidance through an interface that allows users to efficiently navigate media selections and easily identify media that they may desire. An application which provides such guidance is referred to herein as an interactive media guidance application or, sometimes, a media guidance application or a guidance application.

Interactive media guidance applications may take various forms depending on the media for which they provide guidance. One typical type of media guidance application is an interactive television program guide. Interactive television program guides (sometimes referred to as electronic program guides) are well-known guidance applications that, among other things, allow users to navigate among and locate many types of media content including conventional television programming (provided via traditional broadcast, cable, satellite, Internet, or other means), as well as pay-per-view programs, on-demand programs (as in video-on-demand (VOD) systems), Internet content (e.g., streaming media, downloadable media, Webcasts, etc.), and other types of media or video content. Guidance applications also allow users to navigate among and locate content related to the video content including, for example, video clips, articles, advertisements, chat sessions, games, etc. Guidance applications also allow users to navigate among and locate multimedia content. The term multimedia is defined herein as media and content that utilizes at least two different content forms, such as text, audio, still images, animation, video, and interactivity content forms. Multimedia content may be recorded and played, displayed or accessed by information content processing devices, such as computerized and electronic devices, but can also be part of a live performance. It should be understood that the invention embodiments that are discussed in relation to media content are also applicable to other types of content, such as video, audio and/or multimedia.

With the advent of the Internet, mobile computing, and high-speed wireless networks, users are accessing media on personal computers (PCs) and other devices on which they traditionally did not, such as hand-held computers, personal digital assistants (PDAs), mobile telephones, or other mobile devices. On these devices users are able to navigate among and locate the same media available through a television. Consequently, media guidance is necessary on these devices, as well. The guidance provided may be for media content available only through a television, for media content available only through one or more of these devices, or for media content available both through a television and one or more of these devices. The media guidance applications may be provided as on-line applications (i.e., provided on a web-site), or as stand-alone applications or clients on hand-held computers, PDAs, mobile telephones, or other mobile devices. The various devices and platforms that may implement media guidance applications are described in more detail below.

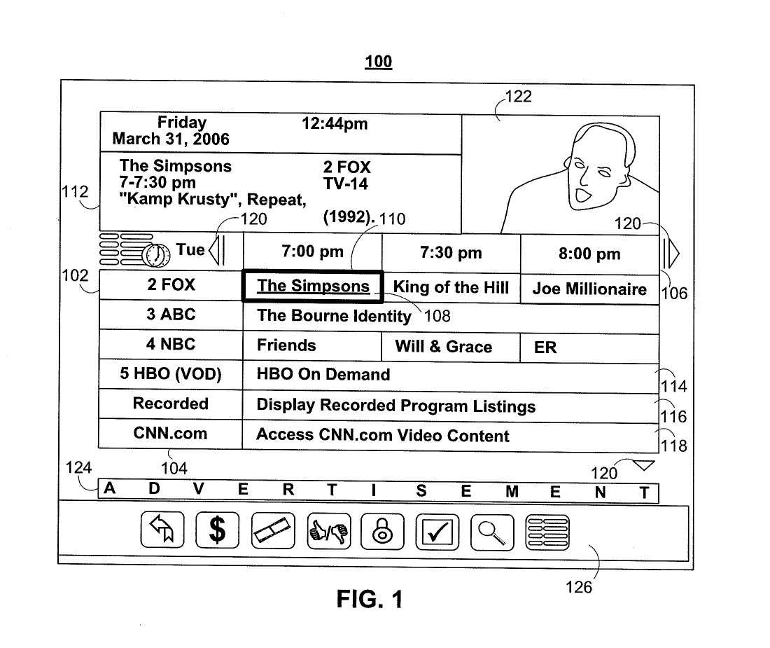

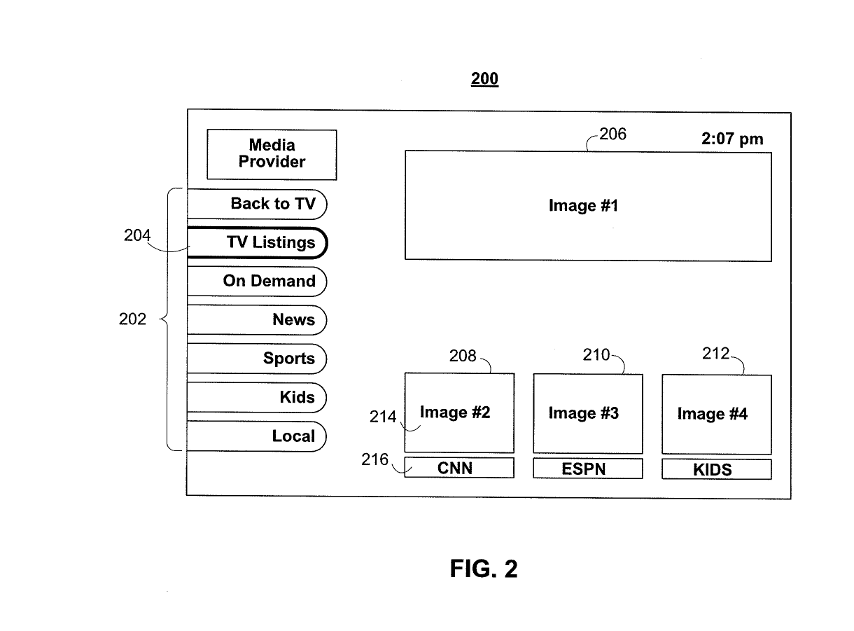

One of the functions of the media guidance application is to provide media listings and media information to users. FIGS. 1-2 show illustrative display screens that may be used to provide media guidance, and in particular media listings. The display screens shown in FIGS. 1-2, 5-10 and 13 may be implemented on any suitable device or platform. While the displays of FIGS. 1-2 and 5-10 and 13 are illustrated as full screen displays, they may also be fully or partially overlaid over media content being displayed. A user may indicate a desire to access media information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media information organized in one of several ways, such as by time and channel in a grid, by time, by channel, by media type, by category (e.g., movies, sports, news, children, or other categories of programming), or other predefined, user-defined, or other organization criteria.

FIG. 1 shows illustrative grid program listings display 100 arranged by time and channel that also enables access to different types of media content in a single display. Display 100 may include grid 102 with: (1) a column of channel/media type identifiers 104, where each channel/media type identifier (which is a cell in the column) identifies a different channel or media type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming provided according to a schedule, the media guidance application also provides access to non-linear programming which is not provided according to a schedule. Non-linear programming may include content from different media sources including on-demand media content (e.g., VOD), Internet content (e.g., streaming media, downloadable media, etc.), locally stored media content (e.g., video content stored on a digital video recorder (DVR), digital video disc (DVD), video cassette, compact disc (CD), etc.), or other time-insensitive media content. On-demand content may include both movies and original media content provided by a particular media provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming media or downloadable media through an Internet web site (e.g., HULU or YOUTUBE) or other Internet access (e.g., FTP).

Grid 102 may provide listings for non-linear programming including on-demand listing 114, recorded media listing 116, and Internet content listing 118. A display combining listings for content from different types of media sources is sometimes referred to as a “mixed-media” display. The various permutations of the types of listings that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In other embodiments, listings for these media types may be included directly in grid 102. Additional listings may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the present invention.

Advertisement 124 may provide an advertisement for media content that, depending on a viewer's access rights (e.g., for subscription programming), is currently available for viewing, will be available for viewing in the future, or may never become available for viewing, and may correspond to or be unrelated to one or more of the media listings in grid 102. Advertisement 124 may also be for products or services related or unrelated to the media content displayed in grid 102.

Advertisement 124 may be selectable and provide further information about media content, provide information about a product or a service, enable purchasing of media content, a product, or a service, provide media content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over media content or a guidance application display or embedded within a display. Advertisements may also include text, images, rotating images, video clips, or other types of media content. Advertisements may be stored in the user equipment with the guidance application, in a database connected to the user equipment, in a remote location (including streaming media servers), or on other storage means or a combination of these locations. Providing advertisements in a media guidance application is discussed in greater detail in, for example, Knudson et al., U.S. patent application Ser. No. 10/347,673, filed Jan. 17, 2003, Ward, III et al. U.S. Pat. No. 6,756,997, issued Jun. 29, 2004, and Schein et al. U.S. Pat. No. 6,388,714, issued May 14, 2002, which are hereby incorporated by reference herein in their entireties. It will be appreciated that advertisements may be included in other media guidance application display screens of the present invention.

Options region 126 may allow the user to access different types of media content, media guidance application displays, and/or media guidance application features. Options region 126 may be part of display 100 (and other display screens of the present invention), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, scheduling a reminder for a program, ordering a program, enabling series recording of a program, setting program and/or channel as a favorite, purchasing a program, or other features. Options available from a main menu display may include search options, VOD options, parental control options, access to various types of listing displays, subscribe to a premium service, edit a user's profile, access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of media content listings displayed (e.g., only HDTV programming, user-specified broadcast channels based on favorite channel selections, re-ordering the display of channels, recommended media content, etc.), desired recording features (e.g., recording or series recordings for particular users, recording quality, etc.), parental control settings, and other desired customizations.

The media guidance application may allow a user to provide user profile information or may automatically compile user profile information. The media guidance application may, for example, monitor the media the user accesses and/or other interactions the user may have with the guidance application. Additionally, the media guidance application may obtain all or part of other user profiles that are related to a particular user (e.g., from other web sites on the Internet the user accesses, such as www.tvguide.com, from other media guidance applications the user accesses, from other interactive applications the user accesses, from a handheld device of the user, etc.), and/or obtain information about the user from other sources that the media guidance application may access. As a result, a user can be provided with a unified guidance application experience across the user's different devices. This type of user experience is described in greater detail below in connection with FIG. 4. Additional personalized media guidance application features are described in greater detail in Ellis et al., U.S. patent application Ser. No. 11/179,410, filed Jul. 11, 2005, Boyer et al., U.S. Pat. No. 7,165,098, issued Jan. 16, 2007, and Ellis et al., U.S. patent application Ser. No. 10/105,128, filed Feb. 21, 2002, which are hereby incorporated by reference herein in their entireties.

Another display arrangement for providing media guidance is shown in FIG. 2. Video mosaic display 200 includes selectable options 202 for media content information organized based on media type, genre, and/or other organization criteria. In display 200, television listings option 204 is selected, thus providing listings 206, 208, 210, and 212 as broadcast program listings. Unlike the listings from FIG. 1, the listings in display 200 are not limited to simple text (e.g., the program title) and icons to describe media. Rather, in display 200 the listings may provide graphical images including cover art, still images from the media content, still frames of a video associated with the listing, video clip previews, live video from the media content, or other types of media that indicate to a user the media content being described by the listing. Each of the graphical listings may also be accompanied by text to provide further information about the media content associated with the listing. For example, listing 208 may include more than one portion, including media portion 214 and text portion 216. Media portion 214 and/or text portion 216 may be selectable to view video in full-screen or to view program listings related to the video displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the media provider or based on user preferences. Various systems and methods for graphically accentuating media listings are discussed in, for example, Yates, U.S. patent application Ser. No. 11/324,202, filed Dec. 29, 2005, which is hereby incorporated by reference herein in its entirety.

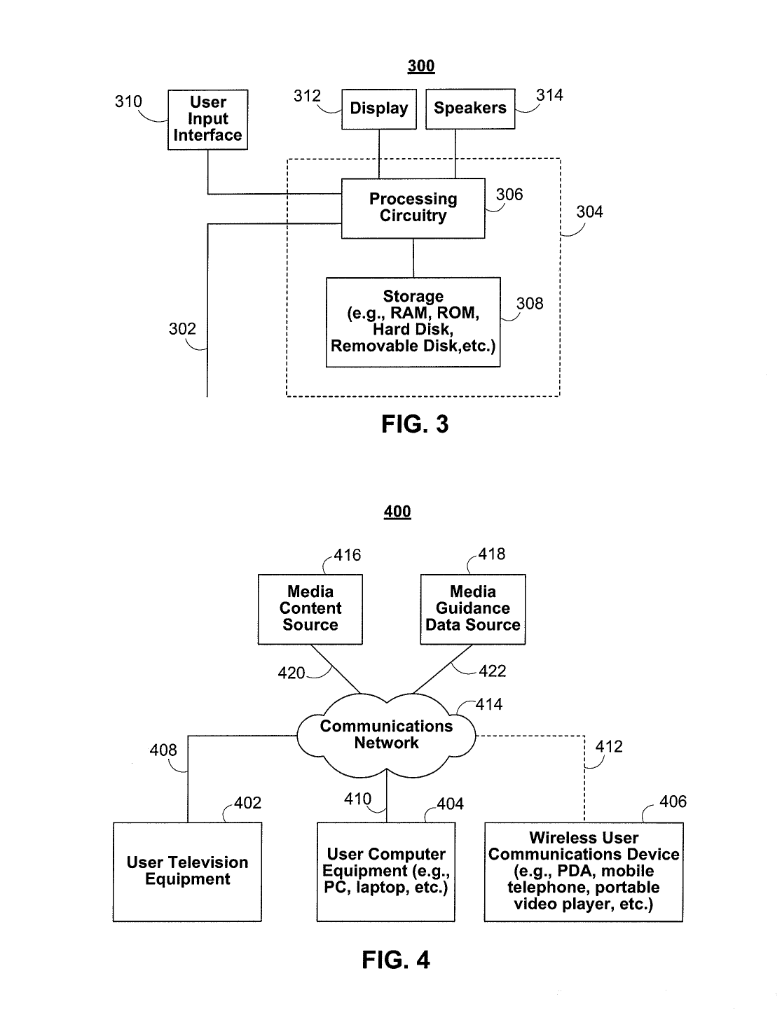

Users may access media content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive media content and data via input/output (hereinafter “I/O”) path 302. I/O path 302 may provide media content (e.g., broadcast programming, on-demand programming, Internet content, and other video or audio) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry 306 such as processing circuitry based on one or more microprocessors, microcontrollers, digital signal processors, programmable logic devices, etc. In some embodiments, control circuitry 304 executes instructions for a media guidance application stored in memory (i.e., storage 308). In client-server based embodiments, control circuitry 304 may include communications circuitry suitable for communicating with a guidance application server or other networks or servers. Communications circuitry may include a cable modem, an integrated services digital network (ISDN) modem, a digital subscriber line (DSL) modem, a telephone modem, or a wireless modem for communications with other equipment. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory (e.g., random-access memory, read-only memory, or any other suitable memory), hard drives, optical drives, or any other suitable fixed or removable storage devices (e.g., DVD recorder, CD recorder, video cassette recorder, or other suitable recording device) may be provided as storage 308 that is part of control circuitry 304. Storage 308 may include one or more of the above types of storage devices. For example, user equipment device 300 may include a hard drive for a DVR (sometimes called a personal video recorder, or PVR) and a DVD recorder as a secondary storage device. Storage 308 may be used to store various types of media described herein and guidance application data, including program information, guidance application settings, user preferences or profile information, or other data used in operating the guidance application. Nonvolatile memory may also be used (e.g., to launch a boot-up routine and other instructions).

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting media into the preferred output format of the user equipment 300. Circuitry 304 may also include digital-to-analog converter circuitry and analog-to-digital converter circuitry for converting between digital and analog signals. The tuning and encoding circuitry may be used by the user equipment to receive and to display, to play, or to record media content. The tuning and encoding circuitry may also be used to receive guidance data. The circuitry described herein, including for example, the tuning, video generating, encoding, decoding, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may control the control circuitry 304 using user input interface 310. User input interface 310 may be any suitable user interface, such as a remote control, mouse, trackball, keypad, keyboard, touch screen, touch pad, stylus input, joystick, voice recognition interface, or other user input interfaces. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. In some embodiments, display 312 may be HDTV-capable. Speakers 314 may be provided as integrated with other elements of user equipment device 300 or may be stand-alone units. The audio component of videos and other media content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally, and data for use by the application is downloaded on a periodic basis (e.g., from the VBI of a television channel, from an out-of-band feed, or using another suitable approach). In another embodiment, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server.

In yet other embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be a EBIF widget. In other embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing media, such as a non-portable gaming machine. For simplicity, these devices may be referred to herein collectively as user equipment or user equipment devices. User equipment devices, on which a media guidance application is implemented, may function as a standalone device or may be part of a network of devices. Various network configurations of devices may be implemented and are discussed in more detail below.

User television equipment 402 may include a set-top box, an integrated receiver decoder (IRD) for handling satellite television, a television set, a digital storage device, a DVD recorder, a video-cassette recorder (VCR), a local media server, or other user television equipment. One or more of these devices may be integrated to be a single device, if desired. User computer equipment 404 may include a PC, a laptop, a tablet, a WebTV box, a personal computer television (PC/TV), a PC media server, a PC media center, or other user computer equipment. WEBTV is a trademark owned by Microsoft Corp. Wireless user communications device 406 may include PDAs, a mobile telephone, a portable video player, a portable music player, a portable gaming machine, or other wireless devices.

It should be noted that with the advent of television tuner cards for PC's, WebTV, and the integration of video into other user equipment devices, the lines have become blurred when trying to classify a device as one of the above devices. In fact, each of user television equipment 402, user computer equipment 404, and wireless user communications device 406 may utilize at least some of the system features described above in connection with FIG. 3 and, as a result, include flexibility with respect to the type of media content available on the device. For example, user television equipment 402 may be Internet-enabled allowing for access to Internet content, while user computer equipment 404 may include a tuner allowing for access to television programming. The media guidance application may also have the same layout on the various different types of user equipment or may be tailored to the display capabilities of the user equipment. For example, on user computer equipment, the guidance application may be provided as a web site accessed by a web browser. In another example, the guidance application may be scaled down for wireless user communications devices.

In system 400, there is typically more than one of each type of user equipment device but only one of each is shown in FIG. 4 to avoid overcomplicating the drawing. In addition, each user may utilize more than one type of user equipment device (e.g., a user may have a television set and a computer) and also more than one of each type of user equipment device (e.g., a user may have a PDA and a mobile telephone and/or multiple television sets).

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.tvguide.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile device (e.g., Blackberry) network, cable network, public switched telephone network, or other types of communications network or combinations of communications networks. BLACKBERRY is a service mark owned by Research In Motion Limited Corp. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes media content source 416 and media guidance data source 418 coupled to communications network 414 via communication paths 420 and 422, respectively. Paths 420 and 422 may include any of the communication paths described above in connection with paths 408, 410, and 412. Communications with the media content source 416 and media guidance data source 418 may be exchanged over one or more communications paths, but are shown as a single path in FIG. 4 to avoid overcomplicating the drawing. In addition, there may be more than one of each of media content source 416 and media guidance data source 418, but only one of each is shown in FIG. 4 to avoid overcomplicating the drawing. (The different types of each of these sources are discussed below.) If desired, media content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Media content source 416 may include one or more types of media distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other media content providers. NBC is a trademark owned by the National Broadcasting Company, Inc., ABC is a trademark owned by the ABC, INC., and HBO is a trademark owned by the Home Box Office, Inc. Media content source 416 may be the originator of media content (e.g., a television broadcaster, a Webcast provider, etc.) or may not be the originator of media content (e.g., an on-demand media content provider, an Internet provider of video content of broadcast programs for downloading, etc.). Media content source 416 may include cable sources, satellite providers, on-demand providers, Internet providers, or other providers of media content. Media content source 416 may also include a remote media server used to store different types of media content (including video content selected by a user), in a location remote from any of the user equipment devices. Systems and methods for remote storage of media content, and providing remotely stored media content to user equipment are discussed in greater detail in connection with Ellis et al., U.S. patent application Ser. No. 09/332,244, filed Jun. 11, 1999, which is hereby incorporated by reference herein in its entirety.

Media guidance data source 418 may provide media guidance data, such as media listings, media-related information (e.g., broadcast times, broadcast channels, media titles, media descriptions, ratings information (e.g., parental control ratings, critic's ratings, etc.), genre or category information, actor information, logo data for broadcasters' or providers' logos, etc.), media format (e.g., standard definition, high definition, etc.), advertisement information (e.g., text, images, media clips, etc.), on-demand information, and any other type of guidance data that is helpful for a user to navigate among and locate desired media selections.

Media guidance application data may be provided to the user equipment devices using any suitable approach. In some embodiments, the guidance application may be a stand-alone interactive television program guide that receives program guide data via a data feed (e.g., a continuous feed, trickle feed, or data in the vertical blanking interval of a channel).

Program schedule data and other guidance data may be provided to the user equipment on a television channel sideband, in the vertical blanking interval of a television channel, using an in-band digital signal, using an out-of-band digital signal, or by any other suitable data transmission technique. Program schedule data and other guidance data may be provided to user equipment on multiple analog or digital television channels. Program schedule data and other guidance data may be provided to the user equipment with any suitable frequency (e.g., continuously, daily, a user-specified period of time, a system-specified period of time, in response to a request from user equipment, etc.). In some approaches, guidance data from media guidance data source 418 may be provided to users' equipment using a client-server approach. For example, a guidance application client residing on the user's equipment may initiate sessions with source 418 to obtain guidance data when needed. Media guidance data source 418 may provide user equipment devices 402, 404, and 406 the media guidance application itself or software updates for the media guidance application.

Media guidance applications may be, for example, stand-alone applications implemented on user equipment devices. In other embodiments, media guidance applications may be client-server applications where only the client resides on the user equipment device. For example, media guidance applications may be implemented partially as a client application on control circuitry 304 of user equipment device 300 and partially on a remote server as a server application (e.g., media guidance data source 418). The guidance application displays may be generated by the media guidance data source 418 and transmitted to the user equipment devices. The media guidance data source 418 may also transmit data for storage on the user equipment, which then generates the guidance application displays based on instructions processed by control circuitry.

Media guidance system 400 is intended to illustrate a number of approaches, or network configurations, by which user equipment devices and sources of media content and guidance data may communicate with each other for the purpose of accessing media and providing media guidance. The present invention may be applied in any one or a subset of these approaches, or in a system employing other approaches for delivering media and providing media guidance. The following three approaches provide specific illustrations of the generalized example of FIG. 4.

In one approach, user equipment devices may communicate with each other within a home network. User equipment devices can communicate with each other directly via short-range point-to-point communication schemes describe above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit media content or scheduled media asset events (e.g., reminders for media assets). For example, a user may transmit media content from user computer equipment to a portable video player or portable music player.

In a second approach, users may have multiple types of user equipment by which they access media content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, program orders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. patent application Ser. No. 10/927,814, filed Aug. 26, 2004, which is hereby incorporated by reference herein in its entirety.

In a third approach, users of user equipment devices inside and outside a home can use their media guidance application to communicate directly with media content source 416 to access media content.

Specifically, within a home, users of user television equipment 404 and user computer equipment 406 may access the media guidance application to navigate among and locate desirable media content. Users may also access the media guidance application outside of the home using wireless user communications devices 406 to navigate among and locate desirable media content.

It will be appreciated that while the discussion of media content has focused on video content, the principles of media guidance can be applied to other types of media content, such as music, images, etc.

In some embodiments, a user may set up user television equipment 402 to forward media asset events (e.g., reminders) to another device (e.g., user computer equipment 404, wireless user communications device 406, or another user television equipment 402) when the user is outside a perceivable range of user television equipment 402. For example, the user may schedule a reminder for a particular asset with user television equipment 402. At a particular time when the reminder is scheduled to notify the user of the media asset, user television equipment 402 (or other remote server or source) may determine whether the user is within a perceivable range of user television equipment 402. When the user is outside of the perceivable range of user television equipment 402, the system may forward the reminder to wireless user communications device 406 along with the media asset or a link to the media asset.

The user may then view the reminder on wireless user communications device 406 and access the media asset on wireless user communications device 406 (or another user television equipment 402, another wireless user communications device 406, or user computer equipment 404). If the user is outside a perceivable range of wireless user communications device 406, wireless user communications device 406 may automatically store the media asset to a storage device. The user may subsequently access the media asset from wireless user communications device 406.

The examples described herein illustrate the user scheduling a media asset event or configuring devices using user television equipment 402 but should be understood to apply to implementations where the user schedules a media asset event using any other device (e.g., user equipment device 300, user computer equipment 404, wireless user communications device 406 or any other type of user equipment suitable for accessing media,). Similarly, the examples described herein illustrate the media asset event being forwarded from user television equipment 402 to other devices but should be understood to apply to implementations where the media asset event is forwarded from user equipment device 300 (user computer equipment 404, wireless user communications device 406, or any other type of user equipment suitable for accessing media) to other devices (e.g., user equipment device 300, user computer equipment 404, wireless user communications device 406 or any other user equipment that is suitable for accessing media).

Additionally, the forwarding of the media asset event may be done using a direct point-to-point communication between devices or through a third party source (e.g., using media content source 416). Similarly, in implementations where the media asset event is forwarded between more than one device, any combination of point-to-point communications and communications through third party sources may be used. For example, user television equipment 402 may forward the media asset event to user computer equipment 404 using a point-to-point communications scheme and if necessary (e.g., the user is outside a perceivable range of user computer equipment 404), user computer equipment 404 may forward the media asset event to wireless user communications device 406 through a third party source (e.g., a remote server on the Internet).

The determination of whether the user is within a perceivable range of a particular device may be done remotely by a third party source or locally by the particular device. For example, in one implementation, user television equipment 402 may determine whether the user is within a perceivable range using a local algorithm or monitoring scheme (discussed below) and thereafter forward the media asset event to the appropriate device. In another implementation, a remote server may ping user television equipment 402 or run a suitable algorithm or monitoring scheme with user television equipment 402 to determine whether the user is within a perceivable range of user television equipment 402. A combination of these two approaches may also be used to determine whether the user is within a perceivable range of user television equipment 402.

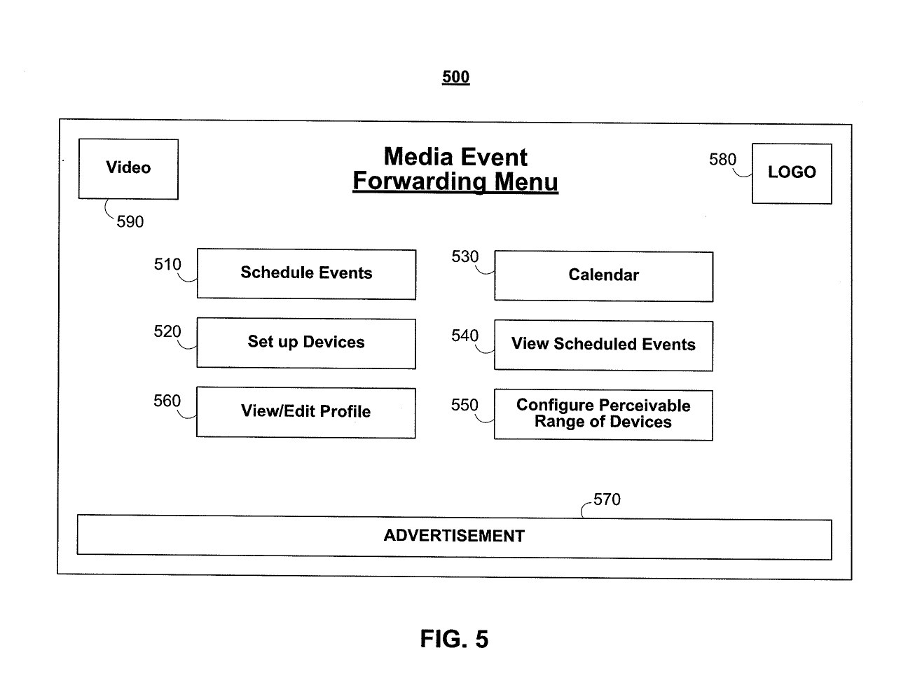

FIG. 5 is an illustrative display of a media asset event forwarding system set up menu screen 500 in accordance with another embodiment of the invention. Screen 500 may include options to schedule events 510, access a calendar 530, set up devices 520, view scheduled events 540, modify a user profile 560, and configure the perceivable range of device 550.

Screen 500 may include an advertisement 570 which may have similar functionality as advertisement 124 (FIG. 1). For brevity, the discussion of advertisement 570 functionality is omitted but should be understood to encompass the same or similar functionality as advertisement 124. Additionally, a logo 580 may be displayed identifying the sponsor of the software application that provides the media asset event forwarding functionality. A video window 590 may also be displayed which may have similar functionality as video region 122 (FIG. 1). For brevity, the discussion of video window 590 functionality is omitted but should be understood to encompass the same or similar functionality as video region 122.

The user may access system set up menu screen 500 to set up the functionality of the media asset event forwarding from any local or remote device. For example, the user may access screen 500 from a remote website using a PDA or other mobile device. In particular, the user may configure the media asset reminder forwarding functionality (discussed in detail below) by accessing a vendor's website (e.g., TVGuide.com). The configuration may be downloaded automatically from the website to the user's home equipment when necessary. The user may also access screen 500 locally using the user television equipment 402 (FIG. 4) to configure the media asset event forwarding functionality.

After user television equipment 402 is configured (remotely or locally), the user may select option to schedule events 510 (e.g., reminders for media assets, schedule a recording). The scheduled events may be forwarded to a device which the user is most likely to be using at the time the event is triggered. For example, the user may schedule a reminder for a media asset over the Internet using a website. The reminder may be configured to notify the user about the media asset at a particular time on the user's computer. At the particular time, if the user's computer is turned OFF, for example, the user television equipment 402 may automatically forward the reminder (and the media asset or a link to the media asset) to a device which is in use by the user (e.g., a mobile phone). The user may receive the notification at the mobile phone (e.g., via an e-mail, SMS or MMS message) and be reminded of the media asset. If the user fails to receive the notification at the mobile phone (e.g., does not open the e-mail SMS or MMS message within a suitable time period), the mobile phone may be configured to store the media asset.

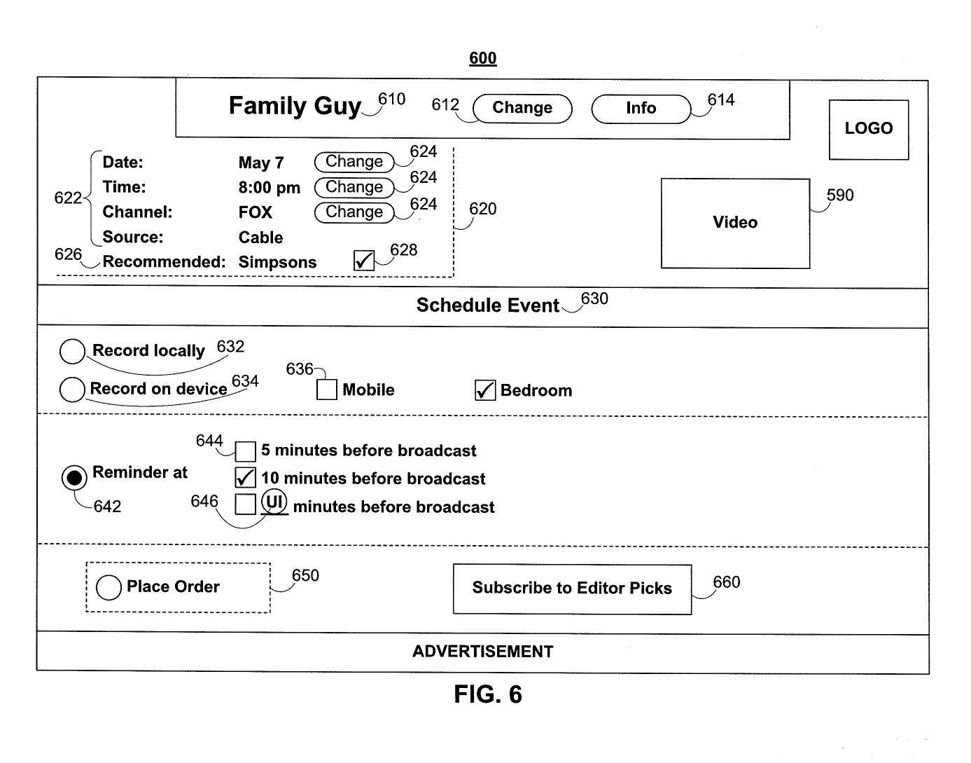

FIG. 6 is an illustrative display of a media asset event scheduling screen 600 in accordance with another embodiment of the invention. In particular, selection of the option to schedule event 510 (FIG. 5) may navigate the user to (or cause the display of) schedule event screen 600. In some implementations, the user television equipment 402 may bring up screen 600, as a result (or in response to) receiving a user selection of a particular program listing 102 (FIG. 1).

For example, the user may navigate a cursor to a program listing of interest and press a SELECT button or click a suitable button on an input device. User television equipment 402 may determine that the media asset associated with the selected program listing is accessible at a future date (or is currently not accessible because of a scheduling or resource conflict). As a result, user television equipment 402 may allow the user to schedule an event for the selected media asset, for example, by displaying screen 600. It should be understood, that although screen 600 is shown as a separate display, some or all of the options of screen 600 may be displayed as an overlay on top of screen 500 or in the same screen from which the user selected the program listing. User television equipment 402 may adjust the size and navigation (e.g., cursor movement or selection) of screen 600 to conform to the display characteristics of the device the user is accessing to schedule events or view program listings.

Schedule events screen 600 may include a media asset selection information portion 620 and an event type selection portion 630. Screen 600 may also include a media asset title 610, an option to change title 612, and an option for media asset information 614. In particular, user television equipment 402 (e.g., using processing circuitry 306 (FIG. 3)) may display the title of the selected media asset as media asset title 610. The user may select option to change title 612 to change the media asset which has been selected. For example, selection of option to change title 612 may navigate the user back to a program listings screen 100 (FIG. 1). Alternatively, user television equipment 402 may display program listings as an overlay in screen 600 to allow the user to navigate the program listings to select a different media asset for which to schedule an event.

The user may also select option for media asset information 614 to view more details on the selected media asset. For example, selection of option for media asset information 614 may bring up a display (separate or as an overlay) of detailed information about the selected media asset or series to which the selected media asset belongs. The display of detailed information may include a preview clip of the selected media asset, such as a short 10-15 second segment of the media asset episode. An option (not shown) may also be provided to allow the user to specify whether the scheduled event applies only to the selected media asset or the entire series to which the media asset belongs.

Media asset selection information portion 620 may include access or source information region 622 for the selected media asset. For example, when the selected media asset is provided by a broadcast source (e.g., cable, satellite or antenna), user television equipment 402 may indicate the date, time, channel and source of the selected media asset. Alternatively, when the selected media asset is an on-demand (or non-linear) type of media asset, user television equipment 402 may only display the source of the media asset and indicate that the media asset is an on-demand (or non-linear) media asset. For example, when the selected media asset is available through a website over the Internet at a particular time (e.g., at HULU.com or YOUTUBE.com), user television equipment 402 may indicate the URL (or website address) of the media asset as the source.

In particular, the user may be interested in a media asset (e.g., a future episode of the show, “The Office”) which is not available over the Internet (e.g., because the media asset has not yet been broadcasted). Additionally, the user may not be aware of when the media asset will become available on the website. Accordingly, the user may use user television equipment 402 to schedule a reminder for the media asset for when it becomes available over the Internet (e.g., at HULU.com). User television equipment 402 may display the URL of the website which may provide the media asset in source information region 622.

Options to change 624 may be displayed next to or in close proximity to each of the items in source information region 620 (i.e., date, time, channel or source). For example, the user may select option to change 624 that is displayed next to the date to select a different date at which the media asset is provided. In some implementations, when the user selects option to change 624 for the date, a display may be provided (e.g., as an overlay) that includes only the future airtime dates of the selected media asset. For example, when the selected asset is only broadcast (or is only available) on every Thursday, when the user selects option to change 624 associated with the date, only dates that correspond to Thursday may be displayed and dates corresponding to different days of the week may be excluded. Similar displays with similar functionality may be provided for each of the option to change 624 associated with the time, channel or source and the discussion for each is omitted for the sake of brevity.

A recommendation 626 display may be provided for a media asset that is related to the selected media asset. A checkbox 628 allows the user to instruct user television equipment 402 to equally apply the event to the recommended media asset. For example, user television equipment 402 may find one or more media assets that are related to the selected media asset and display the related media assets as a recommendation 626. User television equipment 402 may also eliminate some of the assets which are related based on preferences set in the user's profile. The user may mark checkboxes 628 that correspond to the recommended media assets the user likes. User television equipment 402 may then schedule an event, for the user selected recommended assets, that is the same or similar to the event scheduled for the selected media asset identified by media asset title 610.

The media assets which user television equipment 402 searches for to provide recommendations may be restricted to being media assets provided over the same source as the selected asset or that are provided over any source. When the recommended media asset is provided from a different source, user television equipment 402 may notify the user of the difference in sources to allow the user to take appropriate action. For example, the selected media asset may be provided over the Internet while a recommended media asset may be provided over broadcast (e.g., cable, satellite or antenna).

The types of events the user may schedule include scheduling a recording of the selected media asset, scheduling a reminder for the selected media asset, and placing an order for the selected media asset. In addition, the user may use screen 600 to subscribe to editors picks and schedule a reminder for when the editors picks are updated or provided.

For example, editors picks may include all the media assets a particular editor (e.g., a celebrity) schedules for recording or marks as favorite. A user may subscribe to the editors picks associated with the particular editor and view all of the media assets that the editor scheduled for recording or marked as favorite. The user may schedule a reminder to get real-time updates for the editors picks the user subscribes to. When the user is not within a perceivable range of user television equipment 402, user television equipment 402 may forward the reminder (including the updates to the editors picks) to another device so that the user may view the updates on that other device. Editors picks and their functionalities are described in greater detail in U.S. patent application Ser. No. 11/541,217, filed Sep. 29, 2006, which is hereby incorporated by reference herein in its entirety.

Event type selection portion 630 may include radio buttons that allow the user to select the type of event to schedule for the selected media asset. For example, when the user would like to schedule the selected media asset for recording the user may select radio button 632 or 634. In particular, selection of radio button 632 may instruct user television equipment 402 to record the selected media asset locally while selection of radio button 634 may instruct user television equipment 402 to record the selected media asset on another device (e.g., a different user television equipment 402, user computer equipment 404 or wireless user communications device 406).

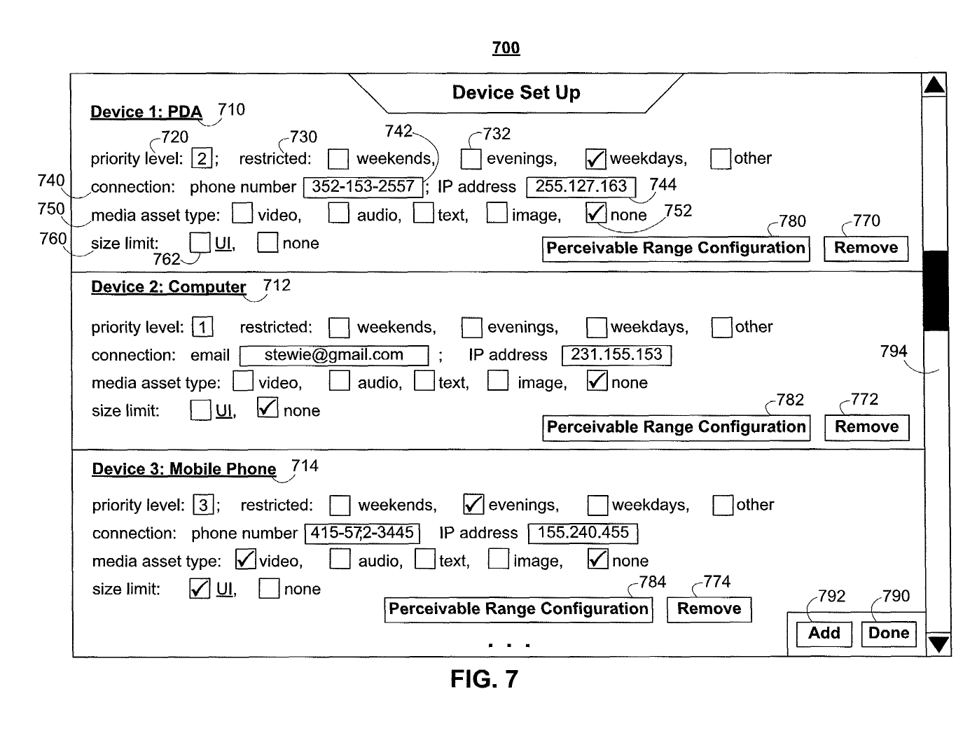

When the user selects radio button 634 to record on another device, the user may also specify which one or more other devices the media asset is to be recorded on. In particular, the user may select checkbox 636 to indicate whether to record the selected media asset in the user equipment located in the bedroom or a mobile device. Any one or more of the devices configured using device configuration screen 700 (FIG. 7) (discussed below), may be selected on which to record the selected media asset by marking checkbox 636.

The user may also instruct user television equipment 402 to record a first part of the media asset on one of the devices that are configured using device configuration screen 700 and a second part of the media asset on a second one of the devices that are configured using device configuration screen 700. This may be desirable, for example, when the selected media asset is too large to fit in the storage of one device in which case user television equipment 402 may transfer the overflow (e.g., the remaining portions of the media asset) to a different device with more storage space.

To schedule a reminder for the selected media asset, the user may select or mark radio button 642. A scheduled reminder may alert or notify the user that the selected media asset is about to begin. For example, the alert or notification may be a prompt or message provided on the display or may be an audible alert. The prompt on the display may be provided five minutes before the selected media asset begins or some other suitable amount of time. The user may select an option displayed in the prompt to tune to or view the selected media asset when it starts.

The user may modify how far in time ahead of the scheduled event the notification or alert is to be displayed (i.e., the lead time) by marking an appropriate checkbox 644. In particular, the user may mark the second checkbox 644 to cause user television equipment 402 to display the alert 10 minutes before the selected media asset begins. The user may also choose any other desirable lead time for the reminder by marking the last checkbox 644 in the display and providing a number as the user input 646. For example, the user may input eleven as user input 646 and user television equipment 402 may provide the alert or prompt eleven minutes before the selected media asset begins.

It should be understood, that as discussed above, instead of navigating to screen 600, the user may optionally schedule a media asset for recording or schedule a reminder for a media asset by selection of a program listing from display 100 (FIG. 1). For example, the user may select a program listing 108 and user television equipment 402 may query the user whether the user would like to schedule a recording or a reminder for the selected media asset. The lead time of the reminder may be a default value (e.g., five minutes) which may be modified by the user.

When the selected media asset is a pay-per-view program or some other program that requires a special order request, the user may schedule the order request by selecting option to place order 650. Selection of option to place order 650 may bring up a display that allows the user to input various payment parameters or a username and password that may be used to complete the order or purchase of the program.

The selected media asset may be ordered in advance of the time at which the media asset becomes available. For example, the user may order a championship fighting match (e.g., selected media asset) which may require payment and is scheduled to take place (and thereby become available) at a later date.

In accordance with some embodiments, when the fighting match takes place, user television equipment 402 may alert the user or prompt the user indicating that the fighting match has previously been ordered and allow the user to access the fighting match. If the user is not within a perceivable range of user television equipment 402 on which the alert or prompt is provided (i.e., the first device), user television equipment 402 may make that determination and transmit data associated with the fighting match to a second device (e.g., by way of e-mail, SMS or MMS message). If the user is able to see or hear the alert or prompt within a suitable period of time (e.g., within 5 minutes of when the fighting match is scheduled to start), the user may access the fighting match on the second device or any other suitable device. If the user is not within a perceivable range of the second device, user television equipment 402 (e.g., using processing circuitry 306) or the second device may try a third device or in the alternative or in addition may store or record the fighting match to a memory or storage device of the second device.

The user may subscribe to updates of editor picks by selecting the option to subscribe to editor picks 660. For example, when the user selects option to subscribe to editor picks 660, the processing circuitry 306 may alert the user or prompt the user indicating that an update to the editor picks is available. If the user is not within a perceivable range of the device on which the alert or prompt is provided, processing circuitry 306 may make that determination and transmit data associated with the update of the editor picks (e.g., by way of e-mail, SMS or MMS message) to a second device. If the user is able to see or hear the alert or prompt for the update of the editor picks, the user may view the updates to the editor picks on the second device or any other suitable device. If the user is not within a perceivable range of the second device, user television equipment 402 may try another device or store or record the updates of the editor picks to a memory or storage device of the second device.

Referring back to FIG. 5, selection of option to set up devices 520 may navigate the user to screen 700 (FIG. 7). In particular, the user may use screen 700 to configure user television equipment 402 with other devices to which user television equipment 402 can forward media asset events. For example, the user may configure various mobile and household devices by using device set up screen 700.

Device set up screen 700 (FIG. 7) includes in a list, first device parameters 710, second device parameters 712 and third device parameters 714. Although the device parameters are displayed in a list, it should be understood that the devices may be displayed in any other suitable form, such as in a mosaic. The name or type of device which is associated with a particular set of parameters may be displayed. For example, first device parameters 710 may be associated with a personal digital assistant (PDA), second device parameters 712 may be associated with a personal computer or laptop and third device parameters 714 may be associated with a mobile phone.

In some implementations, instead of or in addition to displaying the name or type of device, an icon that identifies the device to the user may be displayed with the device parameters. For example, a picture of a handheld computing device may be presented to indicate to the user that first device parameters 710 are associated with a PDA. Although only three devices are shown in screen 700, it should be understood that any number of devices may be displayed within the limits of the size and format of the display screen. When more devices are available than are displayed, the user may scroll the display using scroll bar 794 to view a previous and next set of devices.

Each device may include priority level parameter 720. Priority level parameter may indicate to user television equipment 402 to which device to forward media asset events first. In particular, priority level 720 may be used to instruct user television equipment 402 to first try the device with the highest priority and if the user is outside (or not within) a perceivable range of that device to try the device with the next highest priority level 720. For example, as shown in screen 700, first device parameters 710 (e.g., the PDA) indicate a priority level 720 of two while second device parameters 712 (e.g., personal computer) indicate a higher priority level 720 of one. Accordingly, when user television equipment 402 determines that a media asset event needs to be forwarded (e.g., when the user is outside a perceivable range of the user equipment device), user television equipment 402 may first attempt to forward the media asset event to the second device (e.g., the personal computer) and then attempt to forward the media asset event to the first device (e.g., the PDA).

In some implementations, when user television equipment 402 may forward a media asset event to the device with the lowest priority level 720 (e.g., the mobile phone), user television equipment 402 may instruct that device (e.g., the mobile phone) to store or record the media asset if the user is outside the perceivable range of that device (e.g., the mobile phone). Additionally, if the device with lowest priority parameter 720 is unable to store or record the media asset (e.g., because the media asset is too large in size), user television equipment 402 may instruct the device with the next lowest priority level (e.g., the PDA) to store or record all or part of the media asset.

Alternatively, user television equipment 402 may instruct the device with the highest priority level (e.g., the personal computer) to store or record the media asset. In some implementations, the user may configure user television equipment 402 with separate priority levels for recording or storing the media asset. For example, the user may configure an order (e.g., by setting different priority levels) in which user television equipment 402 attempts to store or record a media asset to one of the devices when the user is outside (or not within) the perceivable range of the device with the lowest priority level.

The user may restrict user television equipment 402 from forwarding a media asset event to one of the devices at particular times. In particular, options to restrict access 730 may be selected by marking various checkboxes 732. For example, the user may configure user television equipment 402 to never forward a media asset event to a particular device on weekends, evenings (e.g., after 6PM), weekdays, or other time frame by marking the appropriate checkboxes 732. The user may specify a restricted time frame range by marking checkbox 732 (marked as “other”).

When a device has restricted access times, user television equipment 402 at those times, may skip forwarding media asset events to that device. For example, a first device may have a higher priority than a second device but may have a restriction during a particular time frame. Accordingly, user television equipment 402 may forward the media asset event to the second device without first attempting to forward the media asset event to the first device during the particular time frame.

Similarly, the user may restrict user television equipment 402 from forwarding, to a device, a media asset event that corresponds to a media asset of a particular type or that exceeds a size limit. In particular, the user may select a media asset type limitation 750 to restrict user television equipment 402 from forwarding media asset events that correspond to particular types. For example, the user may mark checkboxes 752 corresponding to each type (e.g., video, audio, text, image, none) that user television equipment 402 is restricted from forwarding. More specifically, if the user marks the audio checkbox 752, user television equipment 402 may be instructed to skip that particular device when forwarding media asset events that correspond to media assets with audio (e.g., MP3 or WAV files). Marking the “none” checkbox 752 may indicate to user television equipment 402 that no type restrictions are in effect for that device.

The user may place a size limit restriction 760 on a particular device. In particular, the user may instruct user television equipment 402 to skip the device with a size limit restriction when the media asset corresponding to a media asset event has a size that exceeds the size limit specified by checkbox 762. In some implementations, user television equipment 402 may only forward, to the device, a media asset event (e.g., a reminder or alert) that corresponds to a media asset that exceeds the size limit restriction of the device but not forward the media asset itself. This would allow the user to be alerted of the media asset event on the particular device but if the user is outside the perceivable range of the device, user television equipment 402 would not store or record the media asset to that device.

A connection parameter 740 may configure a method of delivery of a media asset event to a particular device. For example, first device parameters 710 that are associated with a PDA may include a phone number 742 or IP Address 744 as connection parameter 740. In particular, user television equipment 402 may dial or transfer data to the first device using the parameters specified in connection parameters 740. More specifically, user television equipment 402 may transmit an SMS, MMS or send an e-mail to the device using a telephone number or by way of the IP address (e.g., through a connection to the Internet). When user television equipment 402 fails to connect or transfer data to a particular device using one of the parameters specified in connection parameter 740 (e.g., telephone number), user television equipment 402 may attempt to connect or transfer data using a different parameter (e.g., IP address). Other modes of connection not shown in screen 700 may include BLUETOOTH, radio, infrared, or any other point-to-point or long-range means of communicating, such as those discussed above in connection with FIG. 4.

An option to remove 770 may be provided for each of the device parameters that is displayed. Selection of option to remove 770 may delete the device and parameters from user television equipment 402 and accordingly user television equipment 402 may not forward media asset events to the deleted device. Selection of option to remove 770 may bring up a confirmation screen (as an overlay or a new screen) to confirm that the user would like to permanently delete the parameters of that device. Additionally, when device parameters are removed or deleted, user television equipment 402 may automatically adjust all the priority levels 720. In particular, user television equipment 402 may reduce all the priority levels higher than the priority of the removed device by one number.

An option to add 792 may be provided to add new device parameters to the list of devices. Selection of option to add 792 may bring up a new screen (as an overlay or a new screen) and request that the user input various parameters. Among the parameters the user may input are a device name or type, a way to connect to the device, a priority level for the new device, and any restrictions (size, type, or time restrictions) that apply to the new device. User television equipment 402 may provide a test option to test whether a connection can be established with the new device to transfer data before adding the device to the list of devices to which user television equipment 402 forwards media asset events.

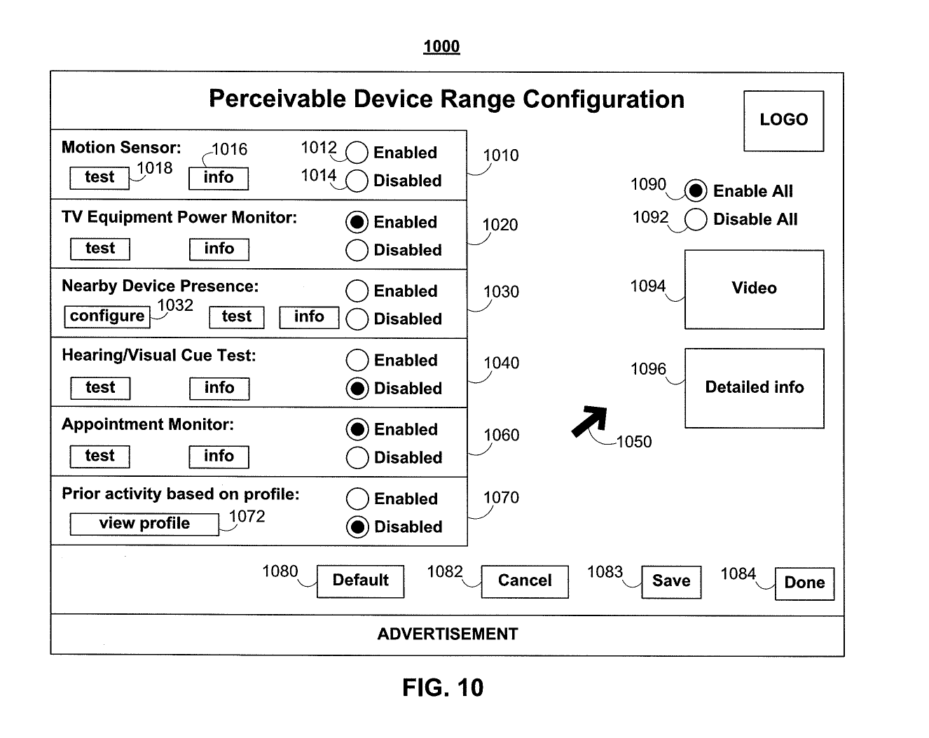

An option to configure perceivable range 780 may be provided for each of the device parameters that is displayed. Selection of option to configure perceivable range 780 may allow the user to configure the settings of the perceivable range of the particular device (e.g., the PDA, personal computer, mobile phone, etc.). Selection of option to configure perceivable range 780 may navigate the user to screen 1000 (FIG. 10) where the user can configure the perceivable range of the corresponding device (discussed in detail below) (or display configuration settings of screen 1000 as an overlay in screen 700).

The user may configure the perceivable range of the device to indicate to user television equipment 402 what types of activity to monitor to determine whether the user is outside (or not within) a perceivable range of a device. For example, the user may turn ON or turn OFF various sensors that detect whether the user is within a perceivable range of a device. In particular, the user may turn ON a sensor that determines whether a display is ON or OFF which may indicate that the user is within or outside a perceivable range of the device. Further details of the sensors and monitors used to determine whether a user is within a perceivable range of a device are discussed below in connection with FIG. 10.

Selection of done option 790 may save all the settings and changes made to the device parameters and return the user to the previous screen or the current program being watched. For example, selection of done option 790 may navigate the user back to media asset event forwarding menu screen 500. Selection of done option 790 may store all the settings to the user's profile in storage 308 locally or on a remote server.

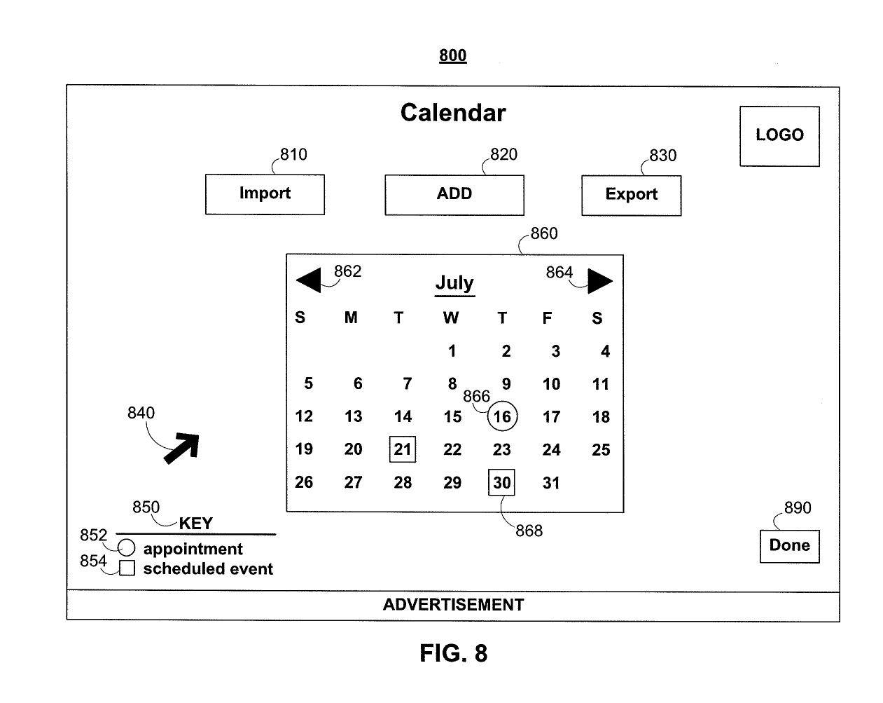

Referring back to FIG. 5, selection of option to access a calendar 530 may navigate the user to screen 800 (FIG. 8). The calendar 860 shown in screen 800 allows the user to view, add or remove appointments and media asset events using a graphical interface.

Calendar screen 800 may include an import function 810, an add function 820, and an export function 830. Selection of import function 810 may allow the user to provide a set of appointments and media asset events which have been scheduled on another device. For example, the user may schedule appointments and media asset events on a PDA or personal computer using, for example, schedule management software like Outlook. In order to avoid having to manually enter each scheduled entry that is on one device into another device, the user may select import function 810.

After the user selects import function 810 using cursor 840 or other suitable selection means, user television equipment 402 may ask the user to select a device from which to import the scheduled appointments and media asset events. User television equipment 402 may then communicate with the selected device to download all the scheduled appointments and media asset events. The user may be given the option to overwrite all of the scheduled events already stored locally in calendar 860 or merge the scheduled appointments and media asset events. The devices may communicate to import the calendar data in any suitable manner such as over the Internet, network, Bluetooth, or other transmission scheme.

After the data has been provided to user television equipment 402, calendar 860 may display all of the scheduled appointments and media asset events. For example, each appointment may be identified in calendar 860 using one type of symbol 866 (e.g., circle) and each media asset event may be identified in calendar 860 using another type of symbol 868 (e.g., square). The user may easily see whether there are conflicting appointments with media asset events. Calendar 860 may also visually identify any conflicts between appointments and media asset events to the user.

User television equipment 402 may also display a key 850 which describes to the user the meaning of the symbols displayed in calendar 860. For example, key 850 may include a symbol 852 that matches the appointment symbol 866 with a description that indicates symbols 852 and 866 correspond to appointments. Similarly, key 850 may include a symbol 854 that matches the media asset event symbol 868 with a description that indicates symbols 854 and 868 correspond to media asset events.

Selection of export function 830 may cause user television equipment 402 to provide all the data (e.g., scheduled appointments and media asset events) to another device. For example, user television equipment 402 may compile all the scheduled appointments and media asset events onto a single file for ease of transfer to another device. The user may store the file to a removable storage device (e.g., a USB key) and then import the file to another device's calendar.

Selection of add function 820 allows the user to schedule appointments or media asset events. For example, when the user selects add function 820, user television equipment 402 may query whether the user would like to schedule an appointment or media asset event. If the user wants to schedule an appointment, user television equipment 402 may allow the user to specify parameters for the appointment (e.g., location, time, date, parties, etc.). If the user wants to schedule a media asset event, user television equipment 402 may navigate the user to screen 600 (FIG. 6).

The user may view later months by selecting right arrow 864 and earlier months by selecting left arrow 862.

As discussed below in connection with FIG. 10, user television equipment 402 may use the appointments scheduled in calendar 860 to determine whether the user is within a perceivable range of the device (e.g., the user equipment device) at a particular time. For example, when a media asset event is scheduled during a time that the user has an appointment scheduled, user television equipment 402 may determine that the user is outside the perceivable range of user television equipment 402 and forward the media asset event to another device. User television equipment 402 may also determine which of a plurality of devices the user is likely to have access to at the appointment and provide the media asset event to the appropriate device based on that determination. Additionally, the user may specify in the appointment parameters which devices are available for receipt of forwarded media asset events along with priority levels for those devices.

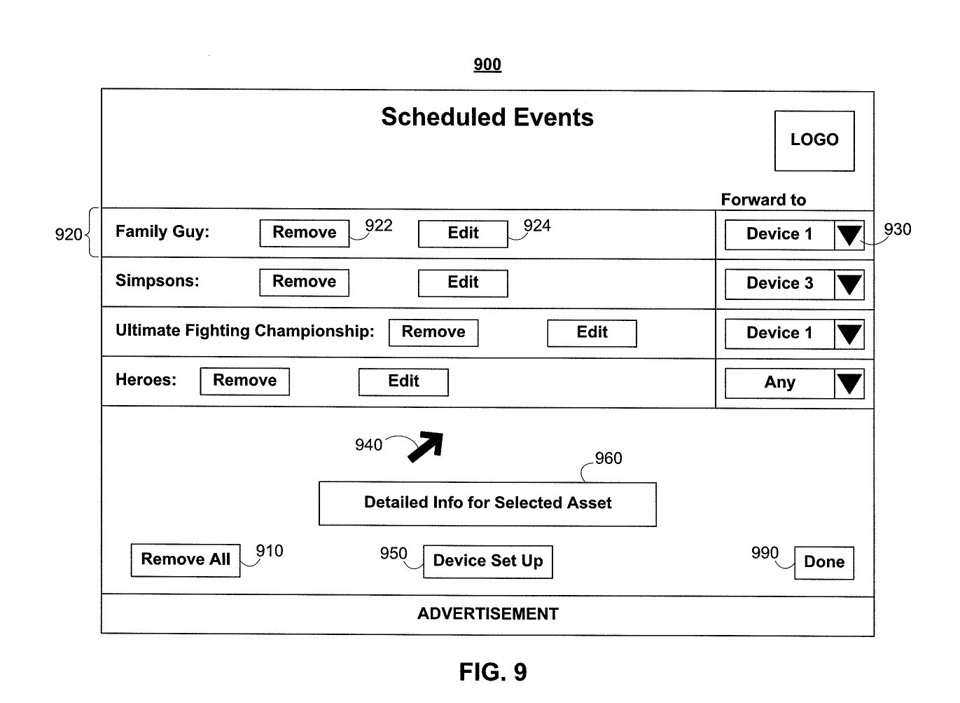

Referring back to FIG. 5, selection of option to view scheduled events 540 may navigate the user to screen 900 (FIG. 9). In particular, scheduled events screen 900 may display a list of all the scheduled media asset events.

Scheduled events screen 900 may include scheduled events listings 920 and media asset event information region 960. When the user navigates to screen 900, user television equipment 402 may retrieve from memory (locally or remotely) a list of all the media asset events scheduled for the user. User television equipment 402 may display each event as a separate listing in order based on earliest event date to latest, alphabetical order of the media asset event titles, random order, or any other suitable user specified or system determined order.

Each media asset event listing 920 may include options to remove 922 and edit 924. The user may select option to remove 922 to cause user television equipment 402 to delete the media asset event from the media asset events schedule. When the media asset event is removed, user television equipment 402 may no longer forward or display an alert or notification for the corresponding media asset. An option to remove all 910 may also be provided to allow the user to delete all the scheduled media asset events quickly. For example, selection of option to remove all 910 may cause user television equipment 402 to delete all the media asset event listings displayed in screen 900 or that are associated with the user. Other options may be provided to simultaneously remove media asset events, for example, that conflict with user appointments, that begin at certain times, that are of certain types, that have common characteristics, or that meet a specified criteria.

Each media asset event listing may also include an identifier (not shown) of the type of event associated with the media asset event listing. For example, Family Guy media asset event listing 920 may include a tape icon indicating that the Family Guy media asset event listing 920 is associated with a recording event. Similarly, Simpsons media asset event listing 920 may include a bell icon indicating that the Simpsons media asset event listing is associated with a reminder event. Any other suitable icon that identifies the media asset event associated with a particular media asset event listing may be displayed.

When the user selects option to edit 924 for a particular media asset event listing, user television equipment 402 may navigate the user to screen 600 (FIG. 6) (or display options of screen 600 as an overlay in screen 900) and display previously saved settings associated with the selected media asset event. The user may then change the previously saved settings associated with the selected media asset.

For example, the user may select option to edit 924 for media asset event listing 920 (e.g., Family Guy). Screen 600 may then be displayed with the previously saved options for the selected media asset event. The user may modify the timing of the reminder by marking a different checkbox 644. The user may save the new settings for the selected asset and be navigated back to media asset events listings screen 900.

The user may also position a cursor 940 over a particular media asset event listing 920 and press a button to select the media asset event listing. User television equipment 402 may display, in information region 960, information about the media asset that corresponds to the selected media asset even listing. Information region 960 may include a preview clip, detailed description, advertisements or other suitable information that is associated with the media asset that corresponds to the selected media asset event listing 920.

In some implementations, user television equipment 402 may automatically display information about a media asset corresponding to a media asset event listing over which cursor 940 is positioned. In particular, if cursor 940 is positioned over a media asset event listing for a predetermined amount of time (e.g., 5 seconds), the media asset event listing may automatically be selected and user television equipment 402 may display information corresponding to the selected media asset event listing in information region 960.

User television equipment 402 may display a forward to drop-down menu 930 for each media asset event listing 920. The forward to drop-down menu 930 may allow a user to select any number of the devices set up in user television equipment 402 (e.g., the devices saved using device set up screen 700). User television equipment 402 may forward the media asset event corresponding to the media asset event listing to the devices selected in drop-down menu 930 for the media asset event listing.

For example, the user may instruct user television equipment 402 to forward Simpsons media asset even listing 920 to device 3 (e.g., a mobile phone). Accordingly, the user may select device 3 from drop-down menu 930 that corresponds to the Simpsons media asset event listing.

The user may select multiple devices from drop-down menu 930 and indicate a priority in which user television equipment 402 attempts to forward the event to the devices. The priority designated in drop-down menu 930 may override any previously defined priority levels for the devices (e.g., priorities set up in screen 700) only for that media asset event listing. For example, the user may select multiple devices for a particular media asset event listing (e.g., Ultimate Fighting Championship) and assign priorities for those devices in drop-down menu 930 that may not match up with the priority levels assigned in screen 700. User television equipment 402 may forward the media asset event associated with Ultimate Fighting Championship in accordance with the priorities assigned using drop-down menu 930 and for a different media asset event, user television equipment 402 may forward the media asset event in accordance with the different priority levels defined in screen 700 for the devices.

The user may also select the “any” device option in drop-down menu 930 to instruct user television equipment 402 to forward the event corresponding to the media asset event listing 920 to all devices set up in user television equipment 402 in accordance with the priority levels set up in screen 700.

The user may select option to set up devices 950 to configure the devices saved in user television equipment 402. In particular, selection of option to set up devices 950 may navigate the user to device set up screen 700.

Selection of done option 990 may save all the settings and changes made to the media asset event listings and return the user to the previous screen or the current program being watched. For example, selection of done option 990 may navigate the user back to media asset event forwarding menu screen 500 (FIG. 5). Selection of done option 990 may store all the settings to the user's profile in storage 308 locally or on a remote server.

Referring back to FIG. 5, selection of option to configure perceivable range of devices 550 may navigate the user to screen 1000 (FIG. 10). Perceivable device range configuration screen 1000 allows the user to set up the monitoring circuit, software or method for each device. In particular, the user may set up how each device determines whether the user is within a perceivable range of the device using perceivable device range configuration screen 1000.

Perceivable device range configuration screen 1000 may display a list or mosaic of all the available mechanisms by which the device determines whether the user is within a perceivable range of the device. The following discussion will be with reference to the mechanisms of user television equipment 402 to determining whether a user is within a perceivable range of user television equipment 402 but similar mechanisms, operation and effect may apply to any other devices that the user sets up to determine whether the user is within a perceivable range of the device. In particular, the user may select a device from a menu (not shown) to configure the perceivable range of the selected device. That configuration is then saved to a remote server or a memory of the selected device and the determination mechanisms are used when necessary. The user may make selections from screen 1000 by moving around a cursor 1050 to a selection.

User television equipment 402 may determine whether a user is within a perceivable range of user television equipment 402 using various sensors and software which may be controlled by the graphical user interface displayed in screen 1000. In particular, screen 1000 may include a motion sensor menu 1010, power monitor menu 1020, nearby device presence sensing menu 1030, hearing/visual cue testing menu 1040, appointment monitoring menu 1060 or prior activity based on a user profile menu 1070.

In some embodiments, user television equipment 402 may determine that the user is within a perceivable range of the user television equipment 402 but may function as if the user were outside the perceivable range of user television equipment 402 (e.g., may store or forward the media asset event to another device). In particular, user television equipment 402 may function as if the user were outside the perceivable range of user television equipment 402 when a storage capacity of user television equipment 402 is reached (and the media asset cannot be access using user television equipment 402), a component necessary for accessing the media asset corresponding to the media asset event is not functioning properly, resources necessary for accessing the media asset corresponding to the media asset event are not available (e.g., only one tuner is available and that single tuner is in use for another purpose and not available for accessing the media asset), an Internet connection is down or not available, or any other suitable reason.

Motion sensor menu 1010 may control a motion sensing circuit in user television equipment 402. Motion sensing circuit may determine whether a user is within a perceivable range of user television equipment 402 by detecting motion within a particular distance of user television equipment 402 or sensing heat with an infrared sensing circuit. For example, motion sensing circuit may be configured with a particular heat signature associated with the user (e.g., the amount of body heat the user dissipates). At a particular time when an event is scheduled, motion sensing circuit may use an infrared sensing circuit to determine whether the heat signatures of people present in the room match the stored heat signature of the user. When the heat signatures match, user television equipment 402 may determine that the user is within a perceivable range of the device and as such may provide the media asset event on user television equipment. Otherwise, user television equipment 402 may forward the media asset event to another device (as discussed above).

In another implementation, user television equipment 402 may determine whether the user is within a perceivable range of user television equipment 402 by analyzing global positioning system (GPS) coordinates of the user's location at the particular time. For example, user television equipment 402 may monitor the user's GPS coordinates by receiving the coordinates from a GPS device (e.g., a cell phone) which the user may be carrying. The GPS coordinates may be received in real-time, several times a date (random times or predetermined times), on request by user television equipment 402 or by any other suitable means. User television equipment 402 may compare the GPS coordinates of the user's location with the GPS coordinates of user television equipment 402 to determine the distance between user television equipment 402 and the user. When the distance exceeds a predetermined threshold (e.g., more than 20 feet), user television equipment may determine that the user is outside a perceivable range of user television equipment 402. The user may enable or disable the GPS coordinate determination mechanism as discussed above and below in connection with FIG. 10.

In another implementation, motion sensing circuit may determine whether there is a predetermined amount of motion or any motion at all within a particular distance of user television equipment 402. When the motion sensing circuit detects motion within the distance, user television equipment 402 may determine that the user is within a perceivable range of the device and as such may provide the media asset event on user television equipment 402. Otherwise, user television equipment 402 may forward the media asset event to another device (as discussed above).

The user may enable or disable user television equipment 402 to determine whether the user is within a perceivable range of user television equipment 402 using motion sensor circuit by selecting enabled option 1012 or disabled option 1014, respectively. The user may similarly enable or disable user television equipment 402 from determining whether the user is within a perceivable range of user television equipment 402 by selecting the enabled option 1012 or disabled option 1014 for the menu associated with the particular determination mechanism (e.g., menu 1020, menu 1030, menu 1040, menu 1060, and menu 1070).

The user may test any one of the monitoring mechanisms by selecting test option 1018 in the menu for the determination mechanism. For example, the user may select test option 1018 in the motion sensor menu 1010 to test the motion sensor circuit of user television equipment 402. Another option may be provided in motion sensor menu 1010 to configure and store the heat signature of the user for use by the infrared sensing circuit.

In another implementation, the user may press a button or switch in user television equipment 402 indicating that the user is within a perceivable range (or is in the presence) of user television equipment 402. To determine whether the user is within a perceivable range of user television equipment 402, user television equipment 402 may test whether the button or switch indicates that the user is within the perceivable range of user television equipment 402.

The user may request detailed information about any one of the monitoring mechanisms by selecting info option 1016 in the menu for the determination mechanism. For example, the user may select info option 1016 in the motion sensor menu 1010 to request detailed information about the motion sensor circuit of user television equipment 402. User television equipment 402 may display information describing how the selected monitoring mechanism works in detailed information region 1096. The information displayed in region 1096 may include video, audio and/or textual description of the selected monitoring mechanism.

Power monitor menu 1020 may control a power monitor circuit in user television equipment 402. Power monitor circuit may be used by user television equipment 402 to determine whether a user is within a perceivable range of user television equipment 402 by determining whether user television equipment 402 is turned ON or OFF.

For example, at the particular time of the scheduled media asset event, when power monitor circuit is enabled, user television equipment 402 may determine whether the user is within a perceivable range of user television equipment 402 by determining whether a component (e.g., a display or some other hardware component) is turned ON. When user television equipment 402 determines that the component is turned ON at the time of the event, user television equipment 402 may determine that the user is within a perceivable range of user television equipment 402 and as such may provide the media asset event on user television equipment 402. Otherwise, user television equipment 402 may forward the media asset event to another device (as discussed above).

Nearby device presence menu 1030 may control a device presence detection circuit in user television equipment 402. Device presence detection circuit may be used by user television equipment 402 to determine whether a user is within a perceivable range of user television equipment 402 by determining whether a particular device (e.g., a cell phone or PDA that belongs to the user) is within a range (e.g., 15 feet) of user television equipment 402. Device presence detection circuit may make the determination by attempting to communicate with the particular device using a short-range communication scheme (e.g., Bluetooth or Infrared).

Hearing/visual cue test menu 1040 may control the execution of a hearing/visual cue test software application in user television equipment 402. The hearing/visual cue test software application may be used by user television equipment 402 to determine whether a user is within a perceivable range of user television equipment 402 by displaying a symbol and/or playing back a sound and waiting for the user to acknowledge that the user saw or heard the symbol or sound.

For example, the software application may display a symbol of a car and the user may be requested to interact with user television equipment 402 (e.g., by making a selection from a displayed prompt associated with the symbol) to acknowledge that the user saw the symbol within a predetermined time period (e.g., 45 seconds). When the user does not respond or interact as requested within the predetermined time period, the software application may indicate to user television equipment 402 that the user is outside the perceivable range of user television equipment 402.

Appointment monitor menu 1030 may control whether user television equipment 402 monitors appointments stored in the calendar. Monitoring the appointments stored in the calendar may allow user television equipment 402 to determine whether a user is within a perceivable range of user television equipment 402 by determining whether the user has an appointment somewhere away from user television equipment 402 at the time of the scheduled event.

Prior activity based on a user profile menu 1070 may control whether user television equipment 402 monitors the user's profile. Monitoring the user profile may allow user television equipment 402 to determine whether a user is within a perceivable range of user television equipment 402 by determining whether the user in the past has used user television equipment 402 at the time of the scheduled event (e.g., turned user television equipment 402 ON/OFF, changed channels, watched a program that is broadcast at the time of the scheduled event, etc.).

The user may also view or modify the stored profile by selecting view profile option 1072. Similarly, the user may view or modify preference stored in the profile by selecting option to view/edit profile 560 (FIG. 5). User television equipment 402 may retrieve the preferences and setting stored to the user profile and display those settings on the screen. The user may modify the preferences and settings that are displayed and store the changes back to the memory of user television equipment 402 or remote server where the profile is stored.

The user may select to enable all the available monitoring mechanisms by selecting the enable all option 1090 or disable all the monitoring mechanisms by selecting disable all option 1092. When more than one monitoring mechanism is enabled, user television equipment 402 may be configured to determine that the user is within a perceivable range of user television equipment 402 when any one or all of the monitoring mechanisms indicate that the user is within the perceivable range. Priorities may also be assigned for each monitoring mechanism.

For example, when the motion sensor and the power monitor are both enabled, at the time of the event, user television equipment 402 may use the motion sensor and power monitor to determine whether the user is within a perceivable range of user television equipment 402. However, the power monitor may indicate that the user is within a perceivable range of user television equipment 402 (e.g., because the display is turned ON) while the motion sensor may indicate that the user is outside the perceivable range of user television equipment 402. The user may configure user television equipment 402 to give a preference to the indicating provided by one sensor (e.g., the motion sensor) over the indication provided by another sensor (e.g., power monitor). Accordingly, in this situation, user television equipment 402 may determine that the user is outside the perceivable range of user television equipment 402 since the motion sensor with the higher priority (e.g., preference) indicated such.

Alternatively, the use configure user television equipment 402 to determine that the user is within a perceivable range of user television equipment 402 when all of the enabled sensors indicate that the user is within the perceivable range of user television equipment 402. In another implementation, the use configure user television equipment 402 to determine that the user is within a perceivable range of user television equipment 402 when any one of the enabled sensors indicate that the user is within the perceivable range of user television equipment 402.

A default option 1080 may be displayed. The user may select default option 1080 to enable/disable the monitoring mechanisms recommended for user television equipment 402.

Selection of cancel option 1082 may discard all the changes made in screen 1000 and return the user to the previous screen or show that was displayed. Selection of save option 1083 may save all the changes made in screen 1000 to user television equipment 402 without exiting screen 1000. Selection of done option 1084 may save all the settings and changes made to the device parameters and return the user to the previous screen or the current program being watched.

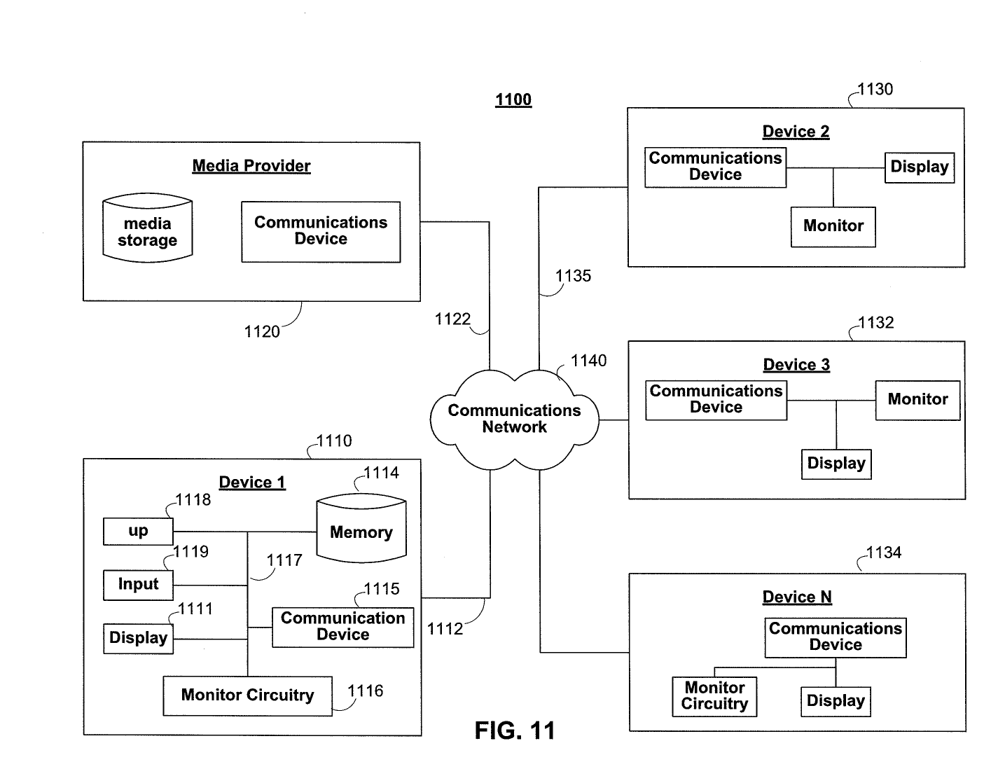

FIG. 11 shows a system 1100 for providing media asset event forwarding in accordance with another embodiment of the invention. System 1100 may include a media provider 1120, a communications network 1140, a first device 1110, a second device 1130 and a third device 1132. Each device 1110, 1130 and 1132 may include processing circuitry 1118, a storage device 1114, internal communications path 1117, monitoring circuitry 1116 and communications device 1115.

Each device 1110, 1130 and 1132 may be implemented as user television equipment 402, user computer equipment 404 or wireless user communications device 406 discussed above in connection with FIG. 4 with the addition of at least monitor circuitry 1116. Similarly, communications network 1140 may be implemented as communications network 414 (FIG. 4). Also, media provider 1120 may be implemented as either or both media content source 416 or media guidance data source 418 (FIG. 4). Each of the devices shown in FIG. 11 may communicate with each other and with media provider 1120 over communications network 1140 (e.g., short-range or long-range communications path).

Monitor circuitry 1116 may implement any or all of the monitoring mechanisms that determine whether a user is within a perceivable range of a device (e.g., first device 111) that are discussed above in connection with FIG. 10. For example, monitor circuitry 1116 may include a motion sensor, an infrared sensor, power monitor, and nearby device presence monitor. Additionally, monitor circuitry 1116 may execute the software code for the software application that runs the hearing/visual cue test, appointment monitor and/or prior activity based on a user profile monitor. The monitor circuitry 1116 may communicate to processor 1118 the results of various monitor mechanisms indicating whether the user is within a perceivable range of the device. As discussed above, the user may enable/disable the various monitoring mechanisms implemented by monitor circuitry 1116.

A user may use first device 1110 to schedule a media asset event. For example, the user may access screen 600 (FIG. 6) using the display 1111 of first device 1110 to select and store a media asset event for a desired media asset. The media asset event may be stored to memory 1114 of first device 1110. Alternatively, the media asset event may be transmitted to and stored remotely on a server, such as media provider 1120.

At the particular time when the media asset event is scheduled to be triggered, first device 1110 may be instructed either by processor 1118 or by the remote server (e.g., media provider 1120) to provide the media asset event to the user. For example, first device 1110 may be instructed to display to the user a reminder for the media asset at the particular time.

First device 1110 may use monitor circuitry 1116 at the particular time to determine whether the user is within a perceivable range of first device 1110 to receive the media asset event. When first device 1110 determines that the user is outside a perceivable range of first device 1110, first device 1110 may forward data associated with the media asset event to second device 1130. Second device 1130 may be selected among a plurality of other devices (e.g., third device 1132 and device N 1134) using priority levels or user designated priorities as discussed above in connection with FIGS. 7 and 9. In some implementations, instead of directly forwarding the data associated with the media asset event from first device 1110 to second device 1130, first device 1110 may inform a remote server (e.g., media provider 1120) that the user is outside a perceivable range of first device 1110 and the remote server may forward the data associated with the media asset event to the appropriate second device 1130.

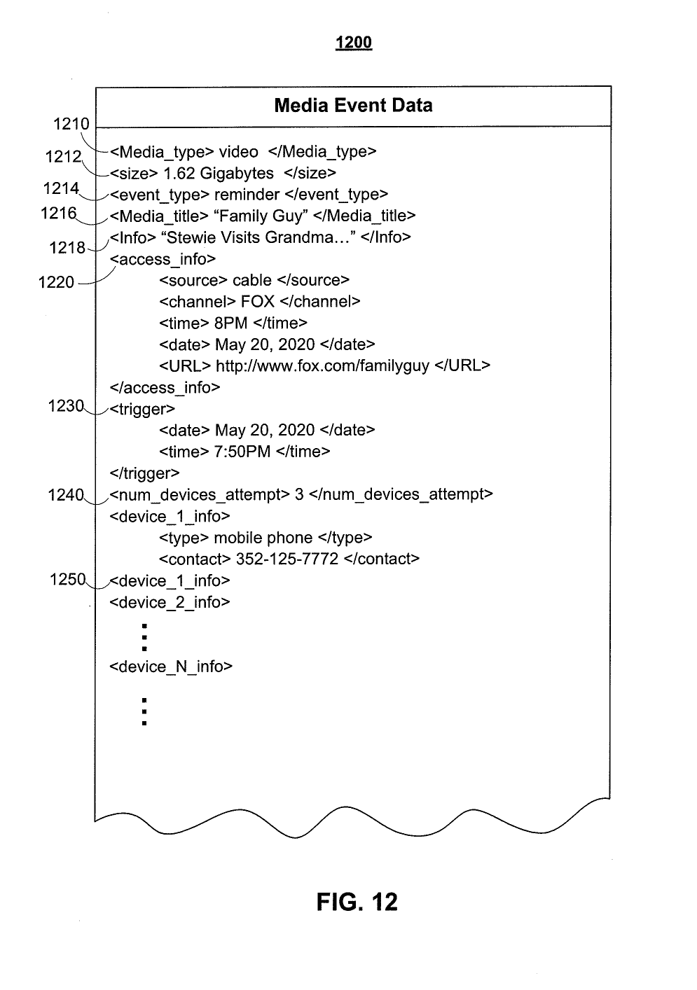

The data associated with the media asset event may be a data structure that includes various fields that identify the media asset and the type of media asset event to another device (e.g., second device 1130). The data associated with media asset event may be of the type shown in FIG. 12. In particular, FIG. 12 shows an exemplary data structure 1200 for a media asset event in accordance with an embodiment of the present invention.

Data structure 1200 may include a media type field 1210, a media asset size field 1212, an event type field 1216, a media asset title field 1218, a media asset information field 1218 and a trigger field 1230. Media type field 1210 and media asset size field 1212 may be used by the devices to determine to which devices not to forward the media asset event. In particular, as discussed above in connection with FIG. 7, media asset type and size restrictions may be stored by the user and accordingly devices may be skipped from receiving media asset event forwards when the data structure 1200 includes fields that are restricted for a particular device.

Trigger field 1230 may indicate when the media asset event is to be provided to the user. For example, a reminder media asset event may be scheduled for five minutes before a corresponding media asset is broadcast. Accordingly, trigger field 1230 may include a particular time (e.g., five minutes before the time and date at which the corresponding media asset is broadcast) to instruct a device to provide the media asset event.

Referring back to FIG. 11, when second device 1130 receives the data associated with the media asset event, second device 1130 may use a local monitor circuitry 1116 or remote monitor circuitry to determine whether the user is within a perceivable range of second device 1130. When the user is within a perceivable range of second device 1130, second device 1130 may provide the media asset event to the user. When the user is outside the perceivable range of second device 1130, second device 1130 may in one implementation access the media asset associated with the media asset event to store the media asset.

Alternatively or in addition to storing the media asset, second device 1130 (when the user is outside the perceivable range of second device 1130) may determine based on information in media event data structure 1200 to which third device to forward the media asset event. For example, data structure 1200 may a num_devices_attempt field 1240 which indicates how many devices the media asset event may be forwarded to (e.g., before being stored on some device) and may be decremented by each device as each device receives the data structure 1200. When a device receives data structure 1200 with num_devices_attempt field 1240 value that is zero, the device may not forward the media asset event to any other device and may store the media asset associated with the media asset event locally or instruct a remote server (e.g., media provider 1120) to store the media asset. When a device receives data structure 1200 with num_devices_attempt field 1240 value that greater than zero, the device may access device information field 1250 to determine the contact or communication means of the next device by which to forward the media asset event to the next device. The device information fields 1250 may correspond to the information provided using screen 700 (FIG. 7).

The media asset may be accessed by first device 1110, second device 1130, third device 1132 or device N 1134 for storage using access information field 1220 in data structure 1200. In particular, the media asset may be accessed by retrieving a website associated with a link stored in access information field 1220. The media asset may be accessed by tuning to a particular channel at the specified data and time in access information field 1220. The media asset may be accessed by having one of the devices in FIG. 11 stream the media asset to another one of the devices. For example, first device 1110 may access the media asset and stream (or transmit the media asset data) to second device 1130 for storage on a memory of second device 1130. This may be desirable when second device 1130 determines the need to store the media asset (e.g., because the user is outside a perceivable range of second device 1130) and the media asset is provided over television signals that need a tuner which may be available on first device 1110 but not on second device 1130. In such a situation, second device 1130 may store the media asset provided over television signals by using the tuner resource of first device 1110 over communications network 1140.

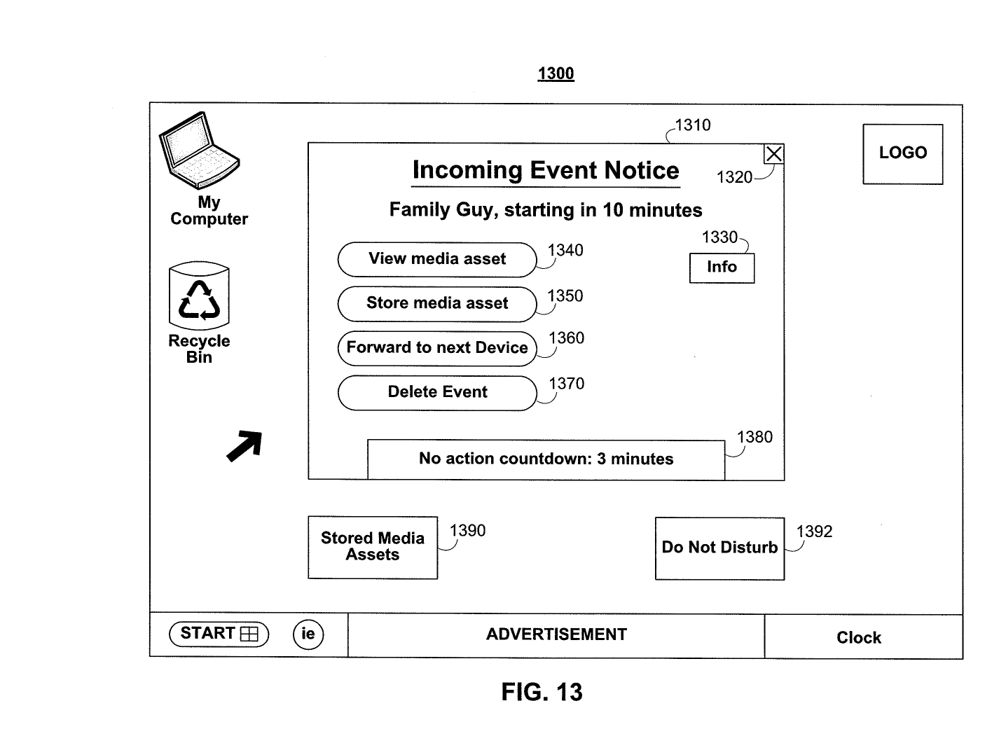

FIG. 13 is an illustrative display 1300 of a media asset event prompt 1310 provided on a second device in accordance with another embodiment of the invention. For example, when user television equipment 402 forwards a media asset event to a mobile device, the mobile device may display prompt 1310 alerting the user of the media asset event that has been received. The media asset event may be received by the second device in the form of a text message (SMS), multimedia message (MMS), e-mail message, instant message, file transfer, or other suitable communications message.

The user may close prompt 1310 by selecting the close button 1320. If the user closes prompt 1310, the second device may function as if the user did not receive the media asset event (e.g., the user is determined to be outside the perceivable range of the second device). In such a situation, the second device may either store the media asset associated with the media asset event or forward the media asset event to another device.

A countdown display 1318 may be provided which counts down an amount of time by which the user has to respond to the media asset event notification. The countdown display 1318 may function as one of the monitoring mechanisms of the second device which determine whether the user is within a perceivable range of the second device. If the user takes no action (e.g., does not acknowledge receipt of the media asset event) within the time period provided in countdown display 1318, the second device may function as if the user did not receive the media asset event (e.g., the user is determined to be outside the perceivable range of the second device). In such a situation, the second device may either store the media asset associated with the media asset event or forward the media asset event to another device.

Media asset event prompt 1310 may include information that identifies the media asset to the user (e.g., a title of the media asset, a time of broadcast of the media asset, a source of the media asset, or any other information provided by data structure 1200). The user may also select an info option 1330 to view detailed information about the media asset.

Media asset event prompt 1310 may include options to view the media asset 1340, store the media asset 1350, forward to the next device 1360, and delete event 1370. Selection of option to view media asset 1340 may cause the second device to display or access the media asset corresponding to the media asset event when the media asset becomes available. For example, media asset event prompt 1310 may be a reminder for a media asset which alerts the user five minutes before the media asset is scheduled for broadcast. Selection of option to view media asset 1340 may cause the second device to tune to the media asset when the media asset is scheduled (e.g., five minutes after the prompt is displayed) or cause another nearby television or device to access the media asset if resources are not available on the second device.

Selection of option to store media asset 1350 may instruct the second device to store the media asset that corresponds to the media asset event to the storage device of the second device. Additionally, when the user selects option to store media asset 1350, the second device may not attempt to forward the media asset event as the user has acknowledged receipt of the media asset event by selecting the option to store media asset 1350.

Selection of option to forward media asset event 1360 may instruct the second device to forward the media asset event to the next device. In particular, selection of option to forward media asset event may cause the second device to function as if the user were outside the perceivable range of the second device. If there are no other devices left to which to forward the media asset event, the second device may automatically store the media asset corresponding to the media asset event to the storage device of the second device or alternatively instruct a different device (e.g., the first device) to store the media asset.

Selection of delete event 1370 may remove the media asset event. In particular, selection of delete event 1370 may cause the second device to not forward the media asset event to another device and not store the media asset corresponding to the media asset event to the storage device of the second device or any other device.

The user of the second device may toggle a do not disturb option 1392. Toggling ON do not disturb option 1392 may automatically force the second device to function as if the user is outside a perceivable range of the second device while do not disturb option 1392 is ON. In particular, even though the monitors of the second device may determine that the user is within a perceivable range of the second device, when option 1392 is toggled ON the device will function as if the monitors indicate that the user is outside the perceivable range and either store the media asset or forward the media asset event. The user may also specify an amount of time for do not disturb option 1392 to be toggled ON such that when the time expires option 1392 is automatically toggled OFF.

The user of the second device may select option to view stored media assets 1390. Selection of option to view stored media assets 1390 may bring up a display of media asset listings that correspond to media assets that are stored to a storage device of the second device. The user may select one of the displayed listings and cause the second device to playback or access the stored media asset.

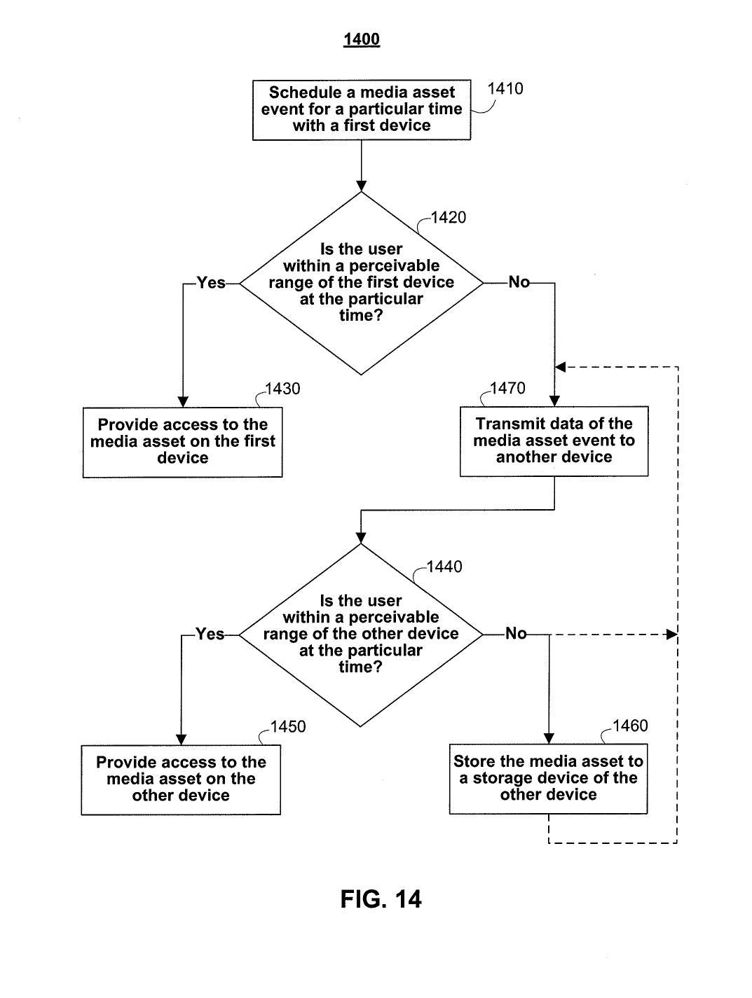

FIG. 14 is illustrative flow diagram 1400 for forwarding media events from one device to another in accordance with embodiments of the present invention. At step 1410, a media asset event is scheduled for a particular time with a first device. For example, a user may use user television equipment 402 to access a media asset event schedule screen 600 to set up and store a media asset event (FIG. 6). The media asset event (e.g., a reminder) may be scheduled for a particular time (e.g., five minutes before the media asset is scheduled for broadcast).

At step 1420, a determination is made as to whether the user is within a perceivable range of the first device at the particular time. For example, user television equipment 402 may determine using the techniques discussed above in connection with FIG. 10 whether the user is within a perceivable range of user television equipment 402. In particular, user television equipment 402 may use monitor circuitry to determine whether the user is within a perceivable range of user television equipment 402. In some implementations, user television equipment 402 may determine that the user is outside a perceivable range of user television equipment 402 when an essential component of accessing the media asset is not available or malfunctioning on user television equipment 402. When it is determined that the user is within the perceivable range of user television equipment 402, user television equipment 402 proceeds to step 1430. Otherwise, user television equipment 402 proceeds to step 1470.

At step 1430, access to the media asset is provided on the first device. In particular, when user television equipment 402 determines that the user is within a perceivable range of user television equipment 402, user television equipment 402 may provide the user with access to the media asset and media asset event.

At step 1470, data associated with the media asset event is transmitted automatically to another device. In particular, when user television equipment 402 determines that the user is outside a perceivable range of user television equipment 402, user television equipment 402 may transmit data associated with the media asset event to another device (e.g., a mobile device). For example, user television equipment 402 may transmit or forward a data structure 1200 (FIG. 12) to one of the devices configured using device configuration screen 700 (FIG. 7). Alternatively, user television equipment 402 may transmit or forward a data structure 1200 (FIG. 12) to a device specified by the user to which to forward media asset events for the particular media asset event.

At step 1440, a determination is made as to whether the user is within a perceivable range of the other device. For example, the second device which may receive the media asset data structure 1200 from the first device may determine using monitor circuitry whether the user is within a perceivable range of the second device. In particular, mobile device (e.g., the second device) may determine using the techniques discussed above in connection with FIG. 10 whether the user is within a perceivable range of the mobile device. As discussed above, in some implementations, the second device may determine that the user is outside a perceivable range of the second device when an essential component of accessing the media asset is not available or malfunctioning on the second device. When it is determined that the user is within the perceivable range of the second device, the second device proceeds to step 1450. Otherwise, the second device proceeds to step 1460.

At step 1450, access to the media asset is provided on the other device. In particular, when the second device determines that the user is within a perceivable range of the second device, the second device may provide the user with access to the media asset and media asset event.

At step 1460, the media asset is stored to a storage device of the other device. In particular, when the second device determines that the user is outside a perceivable range of user television equipment 402, the second device may store the media asset associated with the media asset event to a storage device of the second device. Alternatively or in addition to storing the media asset, as shown by the dashed lines, the second device may return to step 1470 to forward the media asset event (e.g., transmit the media asset event data structure 1200) to another device. Dashed lines shown in FIG. 14 represent optional paths between steps.

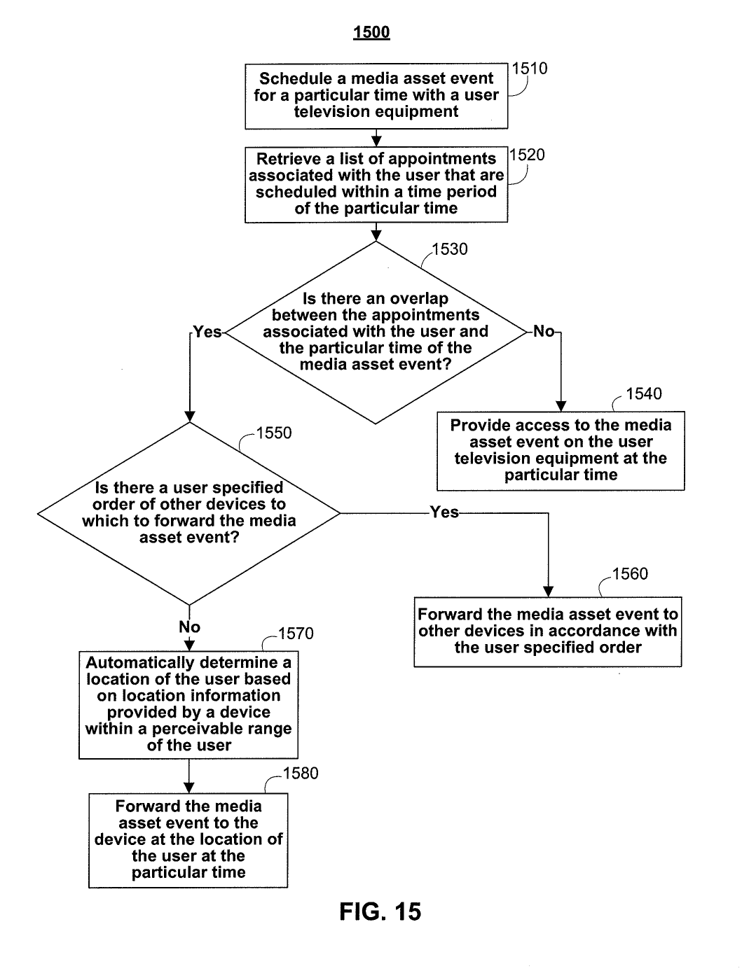

FIG. 15 is illustrative flow diagram 1500 for forwarding media events from one device to another in accordance with embodiments of the present invention. At step 1510, a media asset event is scheduled for a particular time with a user television equipment. For example, a user may use user television equipment 402 to access a media asset event schedule screen 600 to set up and store a media asset event (FIG. 6). The media asset event (e.g., a reminder) may be scheduled for a particular time (e.g., five minutes before the media asset is scheduled for broadcast).

At step 1520, a list of appointments associated with the user that are scheduled within a time period of the particular time are retrieved. For example, user television equipment 402 may retrieve from a memory scheduled appointments and events made with calendar 800 (FIG. 8). In particular, user television equipment 402 may retrieve all the appointments associated with the user for the date the media asset event is scheduled within, for example, a 3 hour time period (e.g., 1.5 hours before the particular time of media asset event and 1.5 hours after the particular time of the media asset event).

At step 1530, a determination is made as to whether there is an overlap between the appointments associated with the user and the particular time of the media asset event. For example, user television equipment 402 may compare each of the retrieved list of times with the particular time of the media asset event. When the retrieved list of times overlap within, for example, 1.5 hours of the particular time, user television equipment 402 may proceed to step 1550. Otherwise, user television equipment 402 may determine that the user is within a perceivable range of user television equipment 402 at the particular time and proceed to step 1540.

At step 1540, access is provided to the media asset event on the user television equipment at the particular time. For example, the user television equipment may display a reminder for the media asset (e.g., five minutes before the media asset begins). In particular, user television equipment may display a prompt indicating that a media asset associated with the media asset event is about to begin. The user television equipment may allow the user to tune or play back the media asset associated with the media asset event at the particular time.

At step 1550, a determination is made as to whether there is a user specified order of other devices to which to forward the media asset event. For example, user television equipment 402 may determine whether the user designated priority levels for devices as discussed above in connection with screen 700 (FIG. 7). Also, user television equipment 402 may determine whether the user provided a specific device to which to forward media asset events for the particular media asset event as discussed above in connection with screen 900 (FIG. 9). When the user has specified an order of devices to which to forward the media asset event, user television equipment 402 proceeds to step 1560. Otherwise, user television equipment 402 proceeds to step 1570.

At step 1560, the media asset event is forwarded to other devices in accordance with the user specified order. For example, user television equipment 402 may transmit data associated with the media asset event to a first of the devices specified by the user (e.g., a mobile device). In particular, user television equipment 402 may transmit or forward a data structure 1200 (FIG. 12) to the first of the devices specified by the user. More specifically, user television equipment 402 may retrieve the list of other devices configured by the user and transmit the data structure of the media asset event to the device in the list with the highest priority and that does not have any relevant restrictions.

When the user is outside a perceivable range of the first device in the list, the data structure of the media asset event may be forwarded to the device in the list with the next highest priority that does not have any relevant restrictions. The user television equipment 402 may determine what the next device in the list is and provide that information to other devices. The other devices may then determine what the order of the devices to which to forward the media asset event is. Alternatively, each device may determine based on a locally stored list, what the next device in the user specified order is to which to forward the media asset event when the user is outside a perceivable range of the device.

At step 1570, a location of the user based on location information provided by a device within a perceivable range of the user is automatically determined. For example, user television equipment 402 may receive GPS coordinates from a mobile phone or mobile computing device that is with the user. Alternatively or in addition, user television equipment 402 may receive triangulation information from a cellular device that is with the user. In addition, user television equipment 402 may determine based on the appointment schedule of the user where the user will be and what devices will be within the perceivable range of the user.

At step 1580, the media asset event is forwarded to the device at the location of the user at the particular time. For example, user television equipment 402 may forward the media asset event to a mobile computing device (e.g., a laptop or cellular telephone) that is with the user. The mobile computing device may either provide access to the media asset event or alternatively or in addition store the media asset associated with the media asset event to a memory of the mobile computing device. In some implementations, the mobile computing device may forward the media asset event to another device.

The above described embodiments of the present invention are presented for purposes of illustration and not of limitation, and the present invention is limited only by the claims which follow.

1. A method for providing a user with a media asset reminder, the method comprising:
scheduling with a first device, an event for the media asset, wherein the event is triggered at a predetermined time;
determining whether, at the predetermined time, the user is within a perceivable range of the first device; and
when the user is outside the perceivable range of the first device, automatically transmitting data associated with the event to a second device.

2. The method of claim 1, wherein scheduling an event for the media asset comprises scheduling the media asset for recording at the predetermined time.

3. The method of claim 1, wherein the event is a reminder for the media asset.

4. The method of claim 1, wherein scheduling an event for the media asset comprises placing an order for the media asset.

5. The method of claim 1, wherein the predetermined time is user defined, a broadcast time of the media asset, a predetermined period of time before a broadcast time of the media asset, or a time at which the media asset becomes available from a program delivery source.

6. The method of claim 1, wherein determining whether the user is within a perceivable range of the first device comprises monitoring for user inaction at the first device for a particular length of time close to the predetermined time.

7. The method of claim 1, wherein determining whether the user is within a perceivable range of the first device comprises comparing a heat signature of an object that is within a predetermined distance of the first device to a heat signature associated with the user.

8. The method of claim 1, wherein determining whether the user is within a perceivable range of the first device comprises determining whether the user is within viewing range or hearing range of the first device.

9. The method of claim 1, wherein determining whether the user is within a perceivable range of the first device comprises analyzing a user profile to determine, based on past behavior, whether the user is likely to be within the perceivable range of the first device.

10. The method of claim 1, wherein determining whether the user is within a perceivable range of the first device comprises retrieving, from a database, an appointment schedule associated with the user to determine whether the user is at a location remote from the first device at the predetermined time.

11. The method of claim 1, further comprising:
determining whether the media asset is perceivable by the user on the second device at the predetermined time;
when the media asset is perceivable by the user on the second device at the predetermined time, providing the user with access to the media asset on the second device; and
when the media asset is imperceivable by the user on the second device at the predetermined time, storing the media asset to a memory on the second device.

12. The method of claim 11, wherein providing access to the media asset on the second device comprises streaming live video or audio of the media asset to the second device.

13. The method of claim 11, wherein the second device is a mobile device and wherein storing the media asset to a memory comprises storing the media asset to a storage device of the mobile device.

14. The method of claim 1, further comprising:
determining whether the media asset is perceivable by the user on the second device at the predetermined time; and
when the media asset is imperceivable by the user on the second device at the predetermined time, transmitting the data associated with the media asset to a third device.

15. The method of claim 1, further comprising:
determining on which one of a plurality of other devices the media asset is perceivable by the user when the media asset is imperceivable by the user on the first device at the predetermined time; and
transmitting the data associated with the media asset to the one of the plurality of other devices where the media asset is perceivable by the user.

16. The method of claim 1, wherein the data associated with the media asset is the media asset, a link to the media asset, a website address, a television channel number and program delivery source identifier, a message identifying the media asset, a reminder for the media asset, or data that allows the second device to access the media asset.

17. The method of claim 1, wherein the media asset is a television program scheduled for broadcast at the predetermined time, an on-demand media asset, or a pay-per-view program.

18. The method of claim 1, wherein determining whether the user is within a perceivable range of the first device comprises detecting, with the first device, user activity on the second device.

19. A system for providing a user with a media asset reminder, the system comprising:
a processor configured to:
schedule, with a first device, an event for the media asset, wherein the event is triggered at a predetermined time;
determine whether, at the predetermined time, the user is within a perceivable range of the first device; and
when the user is outside the perceivable range of the first device, automatically transmit data associated with the event to a second device.

20. The system of claim 19, wherein the processor is further configured to schedule the media asset for recording at the predetermined time.

21. The system of claim 19, wherein the event is a reminder for the media asset.

22. The system of claim 19, wherein the processor is further configured to place an order for the media asset.

23. The system of claim 19, wherein the predetermined time is user defined, a broadcast time of the media asset, a predetermined period of time before a broadcast time of the media asset, or a time at which the media asset becomes available from a program delivery source.

24. The system of claim 19, wherein the processor is further configured to monitor for user inaction at the first device for a particular length of time close to the predetermined time.

25. The system of claim 19, wherein the processor is further configured to compare a heat signature of an object that is within a predetermined distance of the first device to a heat signature associated with the user.

26. The system of claim 19, wherein the processor is further configured to determine whether the user is within viewing range or hearing range of the first device.

27. The system of claim 19, wherein the processor is further configured to analyze a user profile to determine, based on past behavior, whether the user is likely to be within the perceivable range of the first device.

28. The system of claim 19, wherein the processor is further configured to retrieve, from a database, an appointment schedule associated with the user to determine whether the user is at a location remote from the first device at the predetermined time.

29. The system of claim 19, wherein the processor is further configured to:
determine whether the media asset is perceivable by the user on the second device at the predetermined time;
when the media asset is perceivable by the user on the second device at the predetermined time, provide the user with access to the media asset on the second device; and
when the media asset is imperceivable by the user on the second device at the predetermined time, store the media asset to a memory on the second device.

30. The system of claim 29, wherein the processor is further configured to stream live video or audio of the media asset to the second device.

31. The system of claim 29, wherein the second device is a mobile device and wherein the processor is further configured to store the media asset to a storage device of the mobile device.

32. The system of claim 19, wherein the processor is further configured to:
determine whether the media asset is perceivable by the user on the second device at the predetermined time; and
when the media asset is imperceivable by the user on the second device at the predetermined time, transmit the data associated with the media asset to a third device.

33. The system of claim 19, wherein the processor is further configured to:
determine on which one of a plurality of other devices the media asset is perceivable by the user when the media asset is imperceivable by the user on the first device at the predetermined time; and
transmit the data associated with the media asset to the one of the plurality of other devices where the media asset is perceivable by the user.

34. The system of claim 19, wherein the data associated with the media asset is the media asset, a link to the media asset, a website address, a television channel number and program delivery source identifier, a message identifying the media asset, a reminder for the media asset, or data that allows the second device to access the media asset.

35. The system of claim 19, wherein the media asset is a television program scheduled for broadcast at the predetermined time, an on-demand media asset, or a pay-per-view program.

36. The system of claim 1, wherein the processor is further configured to detect, with the first device, user activity on the second device.

37.-54. (canceled)
